(19) United States
(12) Patent Application Publication
(10) Pub. No.: US 2015/0294247 A1
(43) Pub. Date: Oct. 15, 2015

(54) METHOD OF MANAGING BUSINESS DESCRIPTION, APPARATUS AND STORAGE MEDIUM

(71) Applicant: FUJITSU LIMITED, Kawasaki-shi (JP)

(72) Inventors: Satoshi Munakata, Kawasaki (JP); Naoto TAKAHASHI, Kawasaki (JP); Kuniharu Takayama, Tama (JP)

(73) Assignee: FUJITSU LIMITED, Kawasaki-shi (JP)

(21) Appl. No.: 14/638,207

(22) Filed: Mar. 4, 2015

(30) Foreign Application Priority Data
Apr. 9, 2014 (JP) 2014-080567

(51) Int. Cl. G06Q 10/06

(52) U.S. Cl. CPC G06Q 10/067; G06Q 10/0631

(57) ABSTRACT

A method of managing a business description, the method includes: monitoring an editing state of each of a plurality of business description information pieces stored in a storage device, each of the plurality of business description information pieces describing information indicating each of a plurality of items of work according to a work order; detecting currently edited business description information of which the editing state is in an editing process; detecting edited content of the currently edited business description information; generating, by a processor, related information which is related to specific business description information based on information indicating edited content of the specific business description information and business description information different from the specific business description information among the currently edited business description information pieces; and presenting the generated information.

### CROSS-REFERENCE TO RELATED APPLICATION

This application is based upon and claims the benefit of priority of the prior Japanese Patent Application No. 2014-080567 filed on Apr. 9, 2014, the entire contents of which are incorporated herein by reference.

### FIELD

The embodiment discussed herein is related to a method of managing business description, an apparatus, and a storage medium.

### BACKGROUND

A plurality of items of work performed in business are sorted, information (hereinafter, referred to as business description information) indicating a business description in which a specification of business including each item of work is formally described is prepared as a business model, and a process is performed in which the same business or similar business is executed on an information processing system by using the business model. In a case where a person (hereinafter, referred to as a worker) engaging in business creates a business model of specific business, it is possible to improve creation efficiency of the business model of specific business by using some existing business models.

As an example of a technique of improving creation efficiency of a business model, there is a technique in which information indicating each of a plurality of items of work performed in business is registered in a database, and when a business model is created, the database is searched, and information indicating work as a result of the search is reused in some of the business models. In addition, there is a technique in which information indicating a plurality of items of work performed in business and information indicating a relationship between the plurality of items of work performed in business are stored, and the information indicating the relationship between the items of work presents information indicating the same work or dependent work so as to support creation of a business model. Further, there is a technique in which information indicating work included in a business model is managed, and thus business model creation efficiency is improved.

Japanese Laid-open Patent Publication Nos. 2008-40969, 2009-245177 and 2003-202983 are examples of the related art.

### SUMMARY

According to an aspect of the invention, a method of managing a business description, the method includes: monitoring an editing state of each of a plurality of business description information pieces stored in a storage device, each of the plurality of business description information pieces describing information indicating each of a plurality of items of work according to a work order; detecting currently edited business description information of which the editing state is in an editing process; detecting edited content of the currently edited business description information; generating, by a processor, related information which is related to specific business description information based on information indicating edited content of the specific business description information and business description information different from the specific business description information among the currently edited business description information pieces; and presenting the generated information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of a business description management apparatus related to an embodiment;

FIG. 2 illustrates an example of a computer system;

FIG. 3 illustrates an example of functionally representing the computer system;

FIG. 4 illustrates an example of an employ database;

FIG. 5 illustrates an example of a template database;

FIG. 6 illustrates an example of a business model database;

FIG. 7 illustrates an example of a business history database;

FIG. 8 illustrates an example of a difference applying database;

FIG. 9 illustrates an example of a difference database;

FIG. 10 illustrates an example of a business execution screen;

FIG. 11 illustrates an example of a modeling screen;

FIG. 12 illustrates an example of a cooperation modeling screen;

FIG. 13 illustrates an example of a template management screen;

FIG. 14 is a flowchart illustrating an example of a flow of a process on a worker side;

FIG. 15 is a flowchart illustrating an example of a flow of a process on a server side;

FIG. 16 is a flowchart illustrating an example of a flow of a process on the worker side;

FIGS. 17 and 18 are flowcharts illustrating example of flows of processes on the server side;

FIG. 19 is a flowchart illustrating an example of a flow of a process based on a business model of the worker side;

FIG. 20 illustrates an example of a modeling screen;

FIG. 21 is a flowchart illustrating an example of a flow of an improvement proposal accepting process;

FIG. 22 is a flowchart illustrating an example of a flow of a process performed by an improvement control unit;

FIG. 23 is a flowchart illustrating an example of a process related to a templating proposal;

FIG. 24 illustrates an example of a template creation screen;

FIG. 25 illustrates an example of a cooperation modeling screen;

FIG. 26 is a flowchart illustrating an example of a process related to a proposal to track a change;

FIG. 27 is a flowchart illustrating an example of a process related to a proposal of commonalization;

FIGS. 28 and 29 illustrate examples of proposals to track a change;

FIGS. 30 and 31 illustrate examples of proposals of commonalization;

FIG. 32 is a diagram illustrating a proposal of commonalization;

FIG. 33 illustrates an example of a result of the proposal of commonalization;

FIG. 34 illustrates part of a modification example of the computer system; and

FIG. 35 illustrates functionally representing the part of the modification example.

### DESCRIPTION OF EMBODIMENTS

In business performed by a plurality of workers, there is a case where some items of work may be different between items of business performed by the plurality of workers even in the same business. In addition, in business performed by a plurality of workers, there is a case where the same or similar work as or to work included in different business may be incorporated into business to be performed, and the business may be performed, even in the same business.

Therefore, in a case where a business model is created so as to correspond to business, a business model unique to each of a plurality of workers increases. Due to the increase in the created business model, search results of information indicating work which is performed in order to reuse an existing business model also increase, and thus work time to specify a business model to be reused from the search results increases. There is a case where a business model unique to a worker may be insufficient in versatility, and information indicating work or a business model may not be reused. Therefore, a business model suitable for each worker increases, but a ratio is reduced at which a business model suitable for a certain worker may be reused by other workers.

If part of business is changed, a worker also changes a business model according to a changed portion of the business. When the business model is changed, the worker performs a process of adding or deleting information indicating work corresponding to the changed portion of the business or information indicating a relationship between items of work, or of changing content thereof. However, when a case where the business model is changed, in a case where a large amount of search results are present when information indicating work to be reused as the information indicating work corresponding to the changed portion of the business is searched for, work time to specify information indicating the work to be reused increases. Therefore, when a business model is changed according to a changed portion of business, there is a case where information indicating work or a business model may not be reused.

An aspect of the disclosure is directed to modeling business by presenting information related to business description information which is currently being edited.

Hereinafter, an example of an embodiment of the disclosed technique will be described in detail with reference to the drawings.

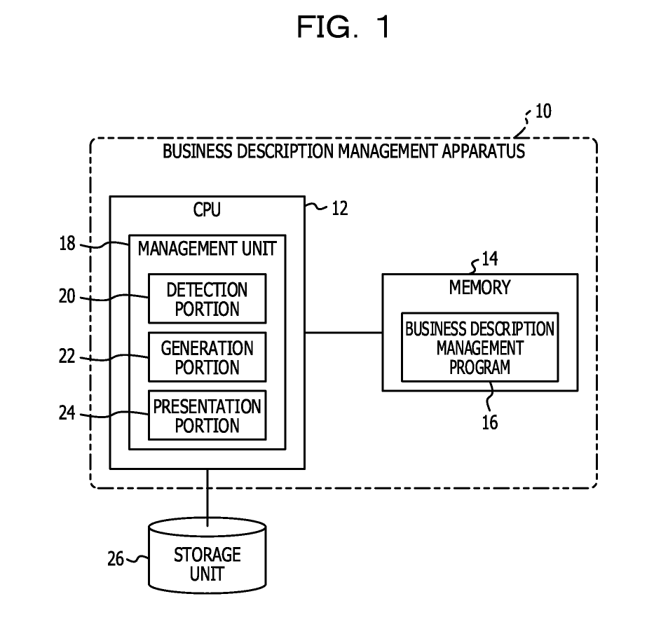

FIG. 1 illustrates an example of a business description management apparatus according to the present embodiment. A business description management apparatus 10 includes a CPU 12 and a memory 14. The memory 14 stores a business description management program 16. In the business description management apparatus 10, the CPU 12 executes the business description management program 16 so as to operate as a management unit 18. In addition, the management unit 18 includes respective portions which operate as functional portions such as a detection portion 20, a generation portion 22, and a presentation portion 24. Further, the business description management apparatus 10 is coupled to a nonvolatile storage unit 26. The storage unit 26 accumulates a plurality of information pieces which include information indicating business including a series of a plurality of items of work, that is, information (business description information) indicating a business description in which information pieces indicating a plurality of respective items of work are described according to an order of a series of a plurality of items of work, information related to the business description, and information indicating a business model.

The storage unit 26 stores a plurality of business description information pieces in which each information piece indicating each of a plurality of items of work is described in an order of the work. The management unit 18 of the business description management apparatus 10 detects currently edited business description information which is in an edited state in which an editing process is performed among the plurality of information pieces stored in the storage unit 26 by using the detection portion 20. The detection portion 20 also detects edited content in the currently edited business description information. The generation portion 22 generates related information which is related to specific business description information in an editing state in which an editing process is performed, based on information indicating the edited content of the currently edited specific business description information, detected by the detection portion 20, and business description information different from specific business description information. The presentation portion 24 presents the generated related information. As mentioned above, by presenting the information related to the currently edited business description information, a worker may check information which is referred to in relation to the currently edited business description information. The worker may promote modeling of business by using the presented information related to the currently edited business description information.

In the business description, information pieces respectively indicating a plurality of items of work are described according to an order of the work. In the present embodiment, a description will be made of information indicating a business description by exemplifying a business model in which a specification of business is formally described. As specific models of the business model, there are a process model and a data model. A difference module may be used to increase productivity of update work or improvement work of a business model. The difference module is information in which a difference (for example, a difference occurring due to an editing operation) between an original business model and a business model at least part of which is changed from the original business model is formally described. The information indicating a difference between the business models before and after being changed is used as a reusable and independent difference module, and thus each of a plurality of business models may be represented by a combination of an original business model and a difference module. In addition, a common portion between the business models before and after being changed is set as a core module.

In an information processing apparatus such as a computer, a plurality of items of work included in business performed by a worker are treated as a task. In other words, the task is information indicating work performed by a worker. In addition, the information processing apparatus such as a computer allocates a worker to a task included in a business model and notifies the worker of the task, and thus the worker may perform work included in business. Further, the information processing apparatus such as a computer processes the task according to the business model, and thus the business is performed.

In order to easily refer to a business model which is a target of performed business, a worker may give any name which is easily understandable by the worker thereto so that the name is registered as information indicating the target business model. In the present embodiment, information (named reference) which refers to a target business model is referred to as a template.

The business description management apparatus 10 is an example of a business description management apparatus in the disclosed technique, and the business description management program 16 is an example of a business description management program in the disclosed technique. In addition, the storage unit 26 in the present embodiment corresponds to a storage unit in the disclosed technique.

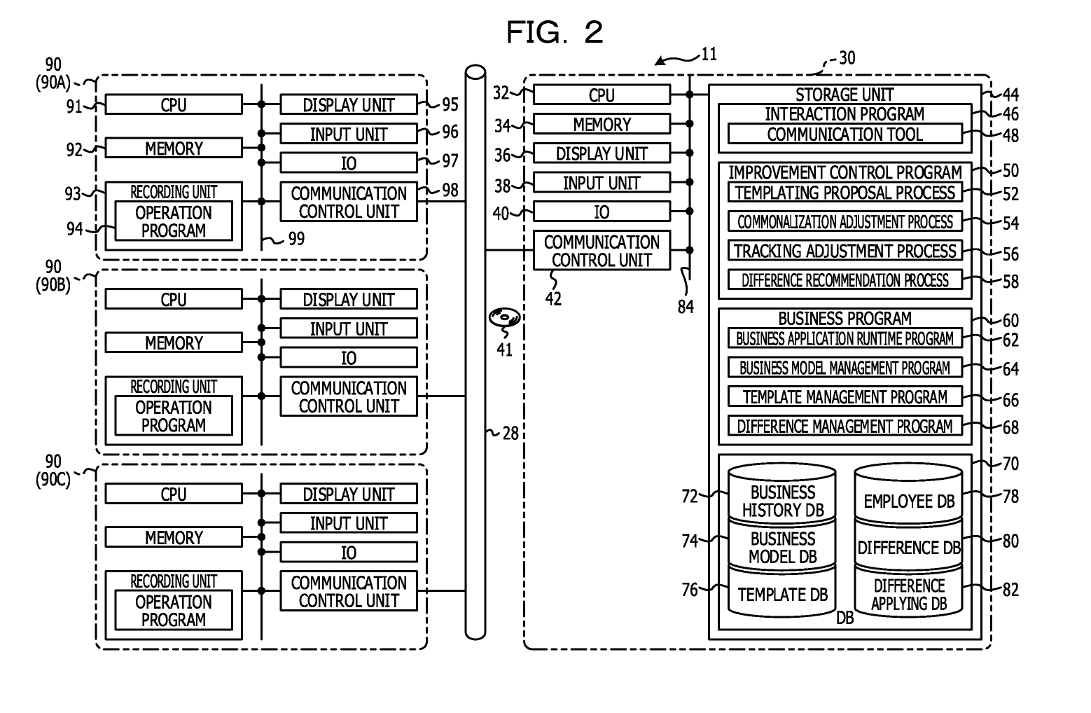

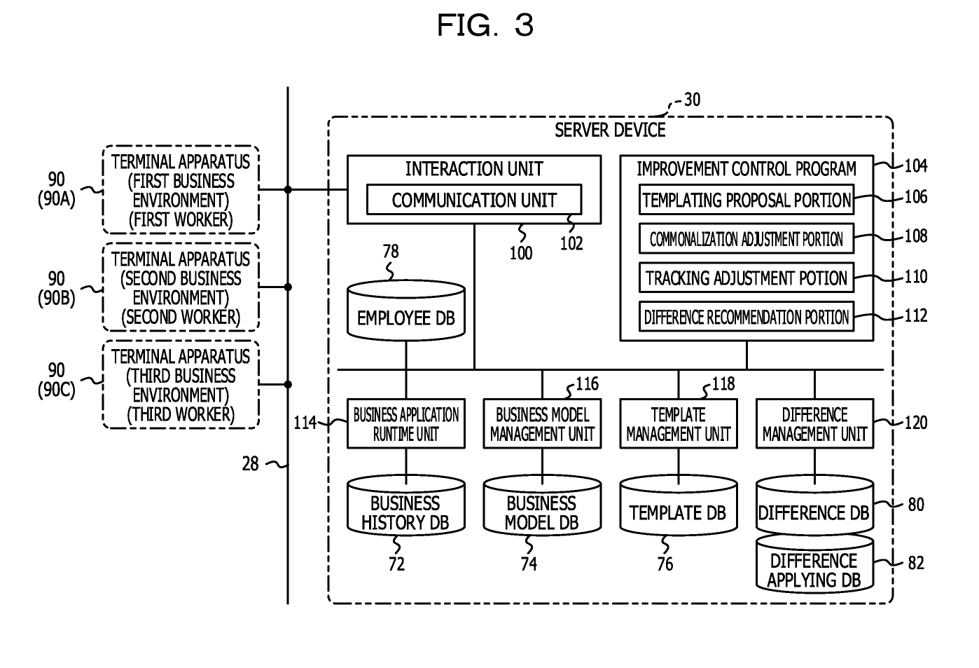

FIG. 2 illustrates a computer system 11 as an example of a system which may implement the business description management apparatus 10 with a computer. FIG. 3 illustrates an example in which the computer system 11 illustrated in FIG. 2 is represented by a functional block. The computer system 11 illustrated in FIGS. 2 and 3 includes a server apparatus 30, and a plurality of (in FIG. 2, two) terminal apparatuses 90. The server apparatus 30 is coupled to each of the plurality of terminal apparatuses 90 via a computer network 28. The business description management apparatus 10 (FIG. 1) may be implemented by the server apparatus 30. In addition, FIG. 2 illustrates an example in which the computer system 11 includes a single server apparatus 30, but the computer system 11 may include a plurality of server apparatuses 30. For example, the server apparatus 30 is a server apparatus which provides a business application which will be described later in detail, and may be implemented by using a single server apparatus and may be implemented by using a plurality of server apparatuses which provide one or more business applications which will be described later in detail. FIG. 2 illustrates an example in which the computer system 11 includes two terminal apparatuses 90, but the computer system 11 may include one or more terminal apparatuses 90.

The server apparatus 30 includes a CPU 32, a memory 34, and a nonvolatile storage unit 44. The CPU 32, the memory 34, and the storage unit 44 are coupled to each other via a bus 84. In addition, the server apparatus 30 includes a display unit 36 such as a display, and an input unit 38 such as a keyboard and a mouse. The display unit 36 and the input unit 38 are coupled to the bus 84. Further, in the server apparatus 30, a device (10 device) 40 for performing reading and writing on an inserted recording medium 41 is coupled to the bus 84. The storage unit 44 is implemented by using a hard disk drive (HDD), a flash memory, or the like. Still further, the server apparatus 30 includes a communication control unit 42 which is an interface for coupling to the computer network 28. The communication control unit 42 is coupled to the bus 84.

The storage unit 44 stores an interaction program 46, an improvement control program 50, a business program 60, and a database (DB) 70. The interaction program 46 includes a communication tool 48 which is a process routine. The improvement control program 50 includes a templating proposal process 52, a commonalization adjustment process 54, a tracking adjustment process 56, and a difference recommendation process 58. The business program 60 includes a business application runtime program 62, a business model management program 64, a template management program 66, and a difference management program 68. The CPU 32 reads the interaction program 46, the improvement control program 50, and the business program 60 from the storage unit 44 and loads the programs on the memory 34, and executes the respective programs, and the server apparatus 30 operate as the management unit 18 (FIG. 1) of the business description management apparatus 10.

The CPU 32 executes the communication tool included in the interaction program 46, and thus the server apparatus 30 operates as a communication portion 102 included in an interaction unit 100 illustrated in FIG. 3. In addition, the CPU 32 executes the improvement control program 50, and thus the server apparatus 30 operates as an improvement control unit 104 illustrated in FIG. 3. Specifically, the CPU 32 executes the templating proposal process 52, and thus the server apparatus 30 operates as a templating proposal portion 106 illustrated in FIG. 3. In addition, the CPU 32 executes the commonalization adjustment process 54, and thus the server apparatus 30 operates as a commonalization adjustment portion 108 illustrated in FIG. 3. Further, the CPU 32 executes the tracking adjustment process 56, and thus the server apparatus 30 operates as a tracking adjustment potion 110 illustrated in FIG. 3. Still further, the CPU 32 executes the difference recommendation process 58, and thus the server apparatus 30 operates as a difference recommendation portion 112 illustrated in FIG. 3.

The CPU 32 executes the business application runtime program 62 included in the business program 60, and thus the server apparatus 30 operates as a business application runtime unit 114 illustrated in FIG. 3. The CPU 32 executes the business model management program 64, and thus the server apparatus 30 operates as a business model management unit 116 illustrated in FIG. 3. The CPU 32 executes the template management program 66, and thus the server apparatus 30 operates as a template management unit 118 illustrated in FIG. 3. The CPU 32 executes the difference management program 68, and thus the server apparatus 30 operates as a difference management unit 120 illustrated in FIG. 3.

The interaction unit 100 including the communication portion 102 may transmit and receive information to and from the terminal apparatus 90 in an interactive manner. The business model management unit 116 may retrieve and register a business model by using a modeling screen (which will be described later in detail). The business model management unit 116 may register a business model and a template by using a cooperation modeling screen (which will be described later in detail). The template management unit 118 may retrieve and register a template by using a template management screen (which will be described later in detail). The business application runtime unit 114 may perform execution of a business model and registration of business history by using a business execution screen (which will be described later in detail). The difference management unit 120 may retrieve and register a difference module by using a modeling screen (which will be described later in detail). The difference management unit 120 may register a difference module by using a cooperation modeling screen (which will be described later in detail).

The improvement control unit 104, as will be described later in detail, may recommend a proposal to template a business model, a proposal to commonalize some business models, a proposal to track a business model change, and a business model. The proposal of templating is to propose a business model which is not registered as a template, and is performed by the templating proposal portion 106. The proposal to commonalize some business models is to propose commonalizing at least some business models among a plurality of business models, and is performed by the commonalization adjustment portion 108. The proposal to track a business model change is to propose causing a business model in use to track a change in a business model which is an adoption source, and is performed by the tracking adjustment potion 110. The recommendation of a business model is to recommend a business model or a difference between business models, and is performed by the difference recommendation portion 112.

The database 70 stored in the storage unit 44 includes a business history database 72, a business model database 74, a template database 76, an employee database 78, a difference database 80, and a difference applying database 82. In the following description, a database is abbreviated to a DB.

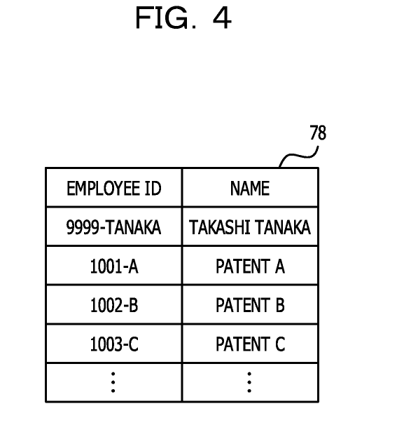

FIGS. 4 to 9 illustrate examples of various DBs stored in the DB 70. FIG. 4 illustrates an example of the employee DB 78. Information related to employees is registered in the employee DB 78. FIG. 4 illustrates an example in which an “employee ID” and the “name” are registered in the employee DB 78.

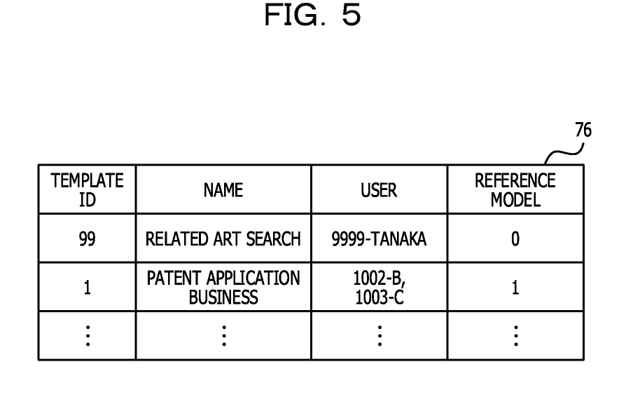

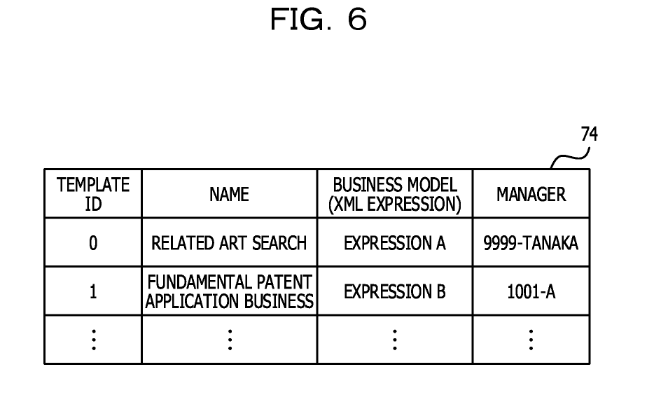

FIG. 5 illustrates an example of the template DB 76. The template DB 76 accumulates information indicating that a user gives a name to a used business model as a template. FIG. 5 illustrates an example in which information pieces regarding a “template ID”, a “name”, a “user”, and a “reference model” are registered in the template DB 76. The employee ID illustrated in the employee DB 78 (FIG. 4) is registered in the “user” information. The model ID indicating a business model illustrated in the business model DB 74 (FIG. 6) is registered in the “reference model” information.

FIG. 6 illustrates an example of the business model DB 74. Information indicating a business model is registered in the business model DB 74. FIG. 6 illustrates an example in which information pieces regarding a “model ID”, a “name”, a “business model”, and a “manager” are registered in the business model DB 74. The employee ID illustrated in the employee DB 78 (FIG. 4) is registered in the “manager” information.

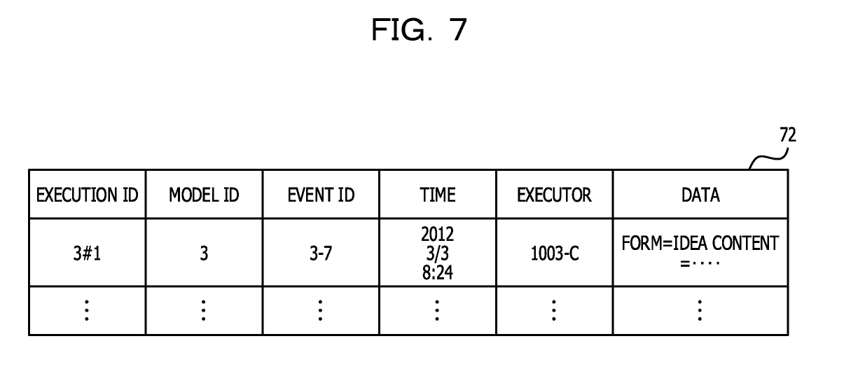

FIG. 7 illustrates an example of the business history DB 72. Information indicating history that business model has been performed is registered in the business history DB 72. FIG. 7 illustrates an example in which information pieces regarding an “execution ID”, a “model ID”, an “event ID”, a “time”, an “executer”, and “data” are registered in the business history DB 72. The model ID indicating a business model illustrated in the business model DB 74 (FIG. 6) is registered in the “model ID” information.

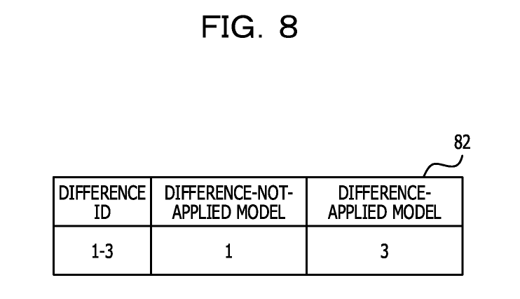

FIG. 8 illustrates an example of the difference applying DB 82. The difference applying DB 82 accumulates information indicating a business model which is generated as a result of applying a difference module to a certain business model. FIG. 8 illustrates an example in which information pieces regarding a “difference ID”, a “model to which a difference module is not applied”, and a “model to which a difference module is applied” are registered in the difference applying DB 82. The model IDs of business models indicating the business models to which a difference module is not applied and is applied, illustrated in the business model DB 74 (FIG. 6) are registered in the information pieces regarding the “model to which a difference module is not applied” and the “model to which a difference module is applied”.

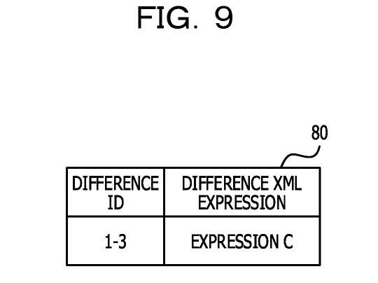

FIG. 9 illustrates an example of the difference DB 80. Information indicating a difference module is registered in the difference DB 80. FIG. 9 illustrates an example in which information pieces regarding a “difference ID” and a “difference XML expression” are registered in the difference DB 80. The difference ID illustrated in the difference applying DB 82 (FIG. 8) is registered in the “difference ID” information.

As illustrated in FIGS. 2 and 3, the computer network 28 is coupled to a plurality of terminal apparatuses 90 (three terminal apparatuses in the example illustrated in FIG. 2) which are operated by workers who engage in business.

Each of the terminal apparatuses 90 includes a CPU 91, a memory 92, and a nonvolatile recording unit 93. The CPU 91, the memory 92, and the recording unit 93 are coupled to each other via a bus 99. The terminal apparatus 90 includes a display unit 95 and an input unit 96. The display unit 95 and the input unit 96 are coupled to the bus 99. Further, in the terminal apparatus 90, an IO device 97 for performing reading and writing on the recording medium 41 is coupled to the bus 99. Still further, the terminal apparatus 90 includes a communication control unit 98 for coupling to the computer network 28. The recording unit 93 records an operation program 94 therein. In the following description, in a case where the plurality of terminal apparatuses 90 or the elements included in the terminal apparatus 90 are individually described, the terminal apparatuses 90 or the elements included in the terminal apparatus 90 are differentiated from each other by adding signs to the reference numerals thereof. For example, the first terminal apparatus 90 in a business environment of a worker who engages in business is indicated as a terminal apparatus 90A.

In addition, in the present embodiment, a series of items of work up to patent application of researched and developed technique will be described as an example of business (hereinafter, referred to as patent application business). Further, a description will be made of an example in which the computer system 11 includes a first terminal apparatus 90A, a second terminal apparatus 90B, and a third terminal apparatus 90C as the terminal apparatuses 90. Still further, in the present embodiment, a description will be made of an example in which, as workers 140 operating the terminal apparatuses 90, a first worker 140A operates the first terminal apparatus 90A, a second worker 140B operates the second terminal apparatus 90B, and a third worker 140C operates the third terminal apparatus 90C. In the present embodiment, the workers 140 include the first worker 140A belonging to a patent management division, and the second worker 140B and the third worker 140C belonging to different sections of a research and development division. Moreover, in the present embodiment, a description will be made of an example in which, as business environments 130 of the workers 140, a business environment of the first worker 140A is a business environment 130A, a business environment of the second worker 140B is a business environment 130B, and a business environment of the third worker 140C is a business environment 130C.

Next, an example of work included in the patent application business will be described.
Temporary specification creating work: This is work of creating a temporary specification based on idea of a technique and a related art search result.
Technique examination work: This is work of improving the idea or discussing whether or not an application is filed with the Patent Office in both departments based on the temporary specification.
Formal specification creating work: This is work of creating a formal specification for filing an application with the Patent Office based on examination content and results.
Filing work with Patent Office: This is work of filing an application with the Patent Office based on the formal specification.

In each of the terminal apparatuses 90, the CPU 91 reads the operation program 94 from the recording unit 93 and loads and executes the operation program 94 on the memory 92, and thus various screens for performing the business are displayed on the display unit 95 of the terminal apparatus 90. As examples of the various screens, there are a business execution screen 200, a modeling screen 220, a cooperation modeling screen 250, and a template management screen 270.

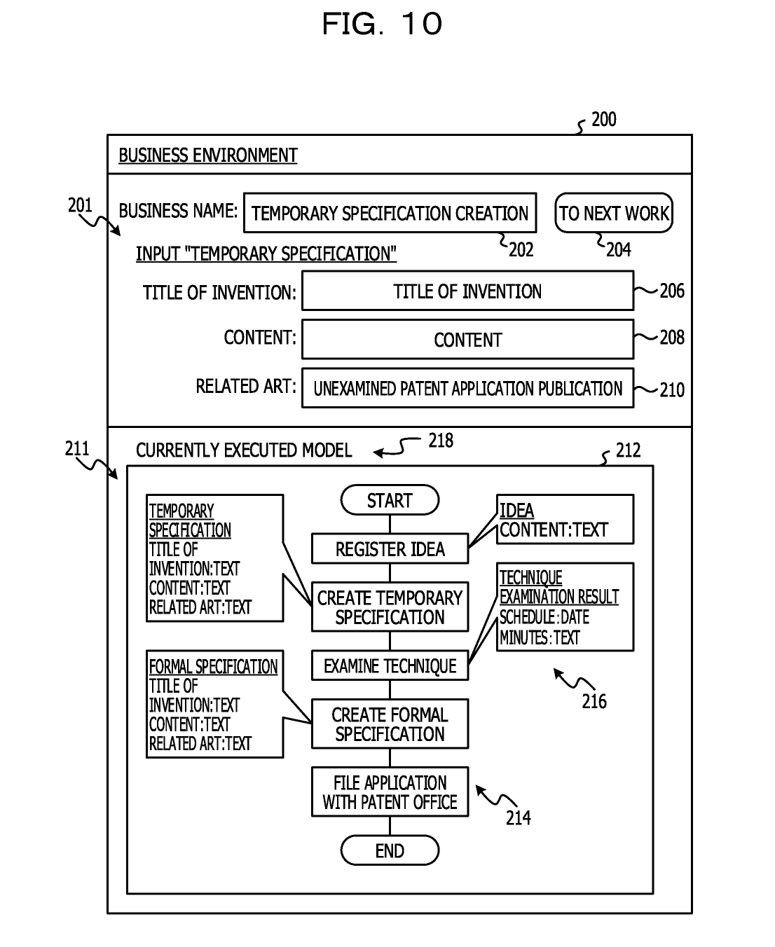

FIG. 10 illustrates an example of the business execution screen 200. The business execution screen 200 displays various information pieces for performing the business by using business models. Specifically, the business execution screen 200 includes a display region 201 for displaying text information indicating the business and a display region 211 for displaying image information which briefly illustrates a business model indicating the business. The display region 201 of text information includes display regions 202, 206, 208 and 210. The display region 202 is a region for displaying information indicating a business name. The display region 206 is a region for displaying information indicating a title of an invention. The display region 208 is a region for displaying information indicating content. The display region 210 is a region for displaying information indicating the related art. The display regions 202, 206, 208 and 210 are also used as input windows in which text information is input or displayed text information is changed through an input operation of the terminal apparatus 90 by a worker. In addition, the display region 201 of text information includes a next work button 204 for receiving an instruction through an input operation of the terminal apparatus 90 by the worker when transferring to the next work.

The display region 211 of image information includes a display region 212 for displaying image information related to a business model. The display region 212 of related image information displays image information 214 in which a business model including information indicating a series of a plurality of items of work included in the business is generated as an image, and comment information 216 indicating information such as a comment of the image information 214. In addition, information 218 indicating that a currently executed business model is displayed in the display region 212 is displayed on an upper part of the display region 212 of related image information.

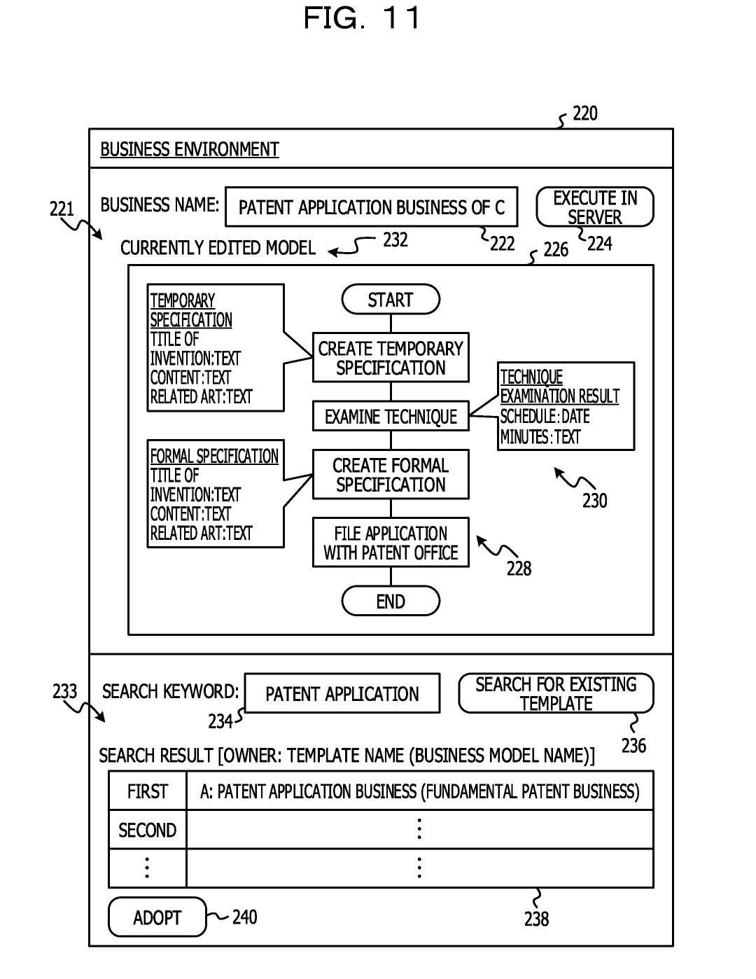

FIG. 11 illustrates an example of the modeling screen 220. The modeling screen 220 displays various information pieces for creating a business model. Specifically, the modeling screen 220 includes a display region 221 for displaying image information in which a business model indicating business is briefly illustrated, and a display region 233 for displaying information for supporting creation of a business model. The display region 221 includes a display region 222 for displaying information indicating a name of business, and a display region 226 for displaying image information related to a business model. The display region 226 displays image information 228 in which a business model is generated as an image, and comment information 230 indicating information such as a comment of the image information 228. The display region 222 for displaying information indicating a name of business is also used as an input window for inputting or changing text information through an input operation of the terminal apparatus 90 by a worker. The display region 226 for displaying image information related to a business model is also used as an input window for inputting text information or graphic information or changing displayed text information or the like through an input operation of the terminal apparatus 90 by the worker. Further, information 232 indicating that a currently edited business model is displayed in the display region 226 is displayed on an upper part of the display region 226. The display region 221 also includes an execution button 224 for receiving an instruction through an input operation of the terminal apparatus 90 by the worker when a business process is performed by the server apparatus 30 according to a business model which has been edited.

The display region 233 of support information displays various information pieces for supporting creation of a business model. Specifically, the display region 233 of support information includes a display region 234 for displaying information indicating part of a business model such as a keyword used to instruct an existing template, and a display region 238 for displaying a search result. The display region 238 illustrated in FIG. 11 is an example in which information pieces regarding ranks of search results, owners of templates, and template names (business model names) are displayed. The display region 234 for displaying information indicating part of a business model, such as a keyword, is also used as an input window for inputting text information such as a keyword or changing displayed text information through an input operation of the terminal apparatus 90 by the worker. The display region 238 for displaying a search result is also used as an input window which allows any one of templates displayed as the search result to be designated through an input operation of the terminal apparatus 90 by the worker. The display region 238 also includes a search button 236 for receiving an instruction through an input operation of the terminal apparatus 90 by the worker on a right side of the display region 234 in a case where an existing template is instructed to be searched for by input information indicating part of a business model. The display region 238 also includes an adoption button 240 for receiving an instruction through an input operation of the terminal apparatus 90 by the worker on a lower side of the display region 238 in a case where a designated template is adopted from among search results.

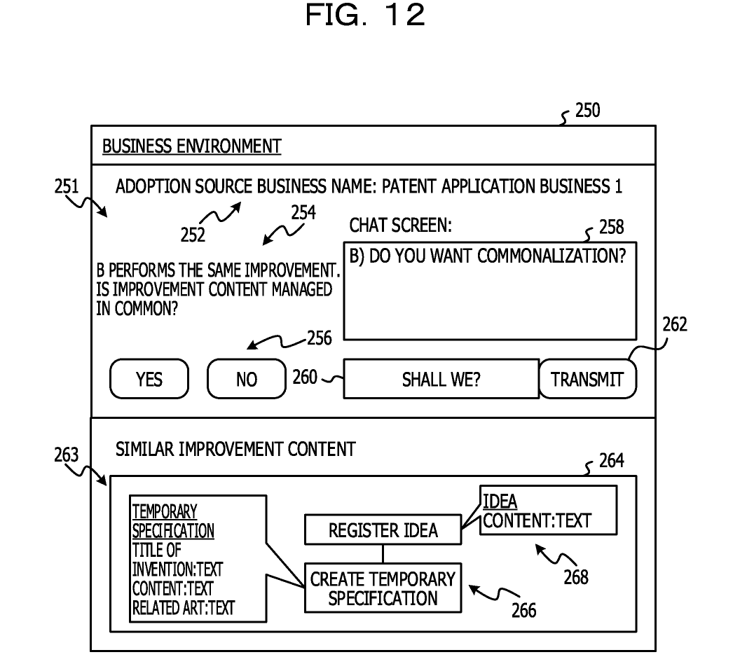

FIG. 12 illustrates an example of the cooperation modeling screen 250. The cooperation modeling screen 250 displays various information pieces for being shared between a plurality of workers in order to improve a business model. Specifically, the cooperation modeling screen 250 includes a display region 251 for displaying information shared between a plurality of workers to a worker who is currently editing a business model, and a display region 263 for displaying image information which briefly illustrates an information sharing target business model. The display region 251 of shared information includes a display region 252 for displaying information indicating a name of target business, and a display region 254 for displaying information indicating content of shared information. The display region 251 includes instruction buttons 256 for receiving an instruction through an input operation of the terminal apparatus 90 by the worker on a lower part of the display region 254 in a case where whether or not sharing information is performed is designated. The display region 251 includes a display region 258 for displaying information (for example, text information) which is transmitted and received between a plurality of workers, and a display region 260 for displaying information which is sent to other workers. The display region 260 is also used as an input window for inputting text information sent to other workers or changing displayed text information through an input operation of the terminal apparatus 90 by the worker. The display region 251 also includes a transmission button 262 for receiving an instruction through an input operation of the terminal apparatus 90 by the worker on a right side of the display region 260 in a case where information displayed in the display region 260 is sent to other workers.

The display region 263 of image information includes a display region 264 for displaying image information indicating content (for example, part of a similar business model) of a business model of which information is shared between a plurality of workers. The display region 263 displays image information 266 in which part of a business model including information indicating some items of work included in business is generated as an image, and comment information 268 indicating information such as a comment of the image information 266.

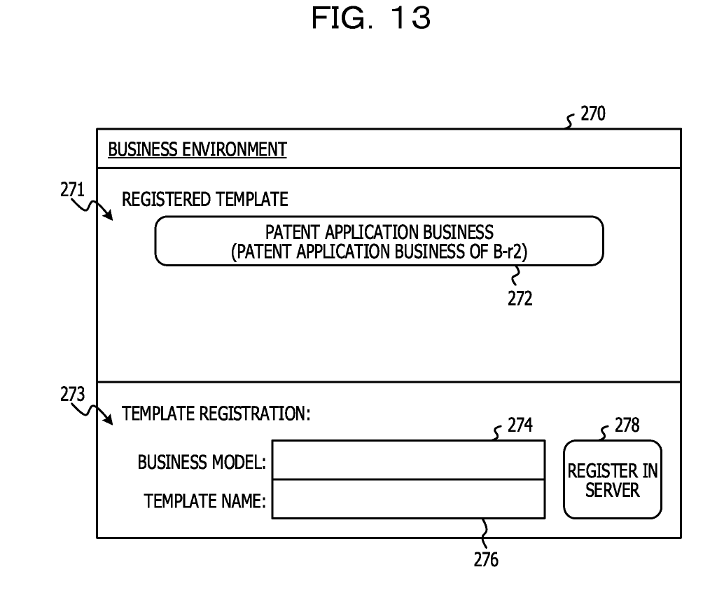

FIG. 13 illustrates an example of the template management screen 270. The template management screen 270 displays various information pieces related to a template in order to manage a business model used by a worker as a template. Specifically, the template management screen 270 a display region 271 for displaying information indicating a registered template, and a display region 273 for displaying information indicating a relationship between a business model to be registered as a template and the template. The display region 271 includes a display region 272 for displaying information indicating a template. The display region 271 includes a display region 272 for displaying information indicating a template. The display region 272 is also used as an input window for allowing a template to be designated among registered templates which are displayed through an input operation of the terminal apparatus 90 by the worker. The display region 273 includes a display region 274 for displaying information indicating a business model which is registered as a template, and a display region 276 for displaying information indicating a template name given to a business model to be registered. The display regions 274 and 276 are also used as input windows for inputting text information or changing displayed text information through an input operation of the terminal apparatus 90 by the worker. The display region 273 includes a registration button 278 for receiving an instruction on a right side of the display regions 274 and 276 in a case where information indicating a correspondence relationship between a business model and a template is registered in the server apparatus 30.

Meanwhile, in order to minimize an increase in a total maintenance cost of a business model and thus to update the business model for improving business or to promote improvement, each business model is preferably divided into a core module and a difference module so as to be restructured. However, for example, in a case where each worker maintains a business model with a high use possibility as a template, maintenance occurs in which each template changes a target business model whenever peripheral business or a business environment of a worker is changed.

For example, in a case where both a template of a first worker and a template of a second worker are changed in a common portion which is common to target business models, man-hours of the first worker and the second worker increase in order to change the business models. In a case where a plurality of workers manage a template which is used in common on an organization basis, the following phenomena also occur. A first phenomenon is that diversity of individual diversity disappears. A second phenomenon is that a configuration of an organization which is desirable in commonalizing a template may not match a configuration of an organization of business.

Therefore, a business model is divided into a core module (common portion) and a difference module, and the core module is maintained by a worker suitable for commonalization beyond the organization configuration, so that a total maintenance cost of a plurality of templates may be reduced. On the other hand, in a case where the core module is changed, the change is preferably spread to a template which refers to a business model including the changed core module.

In order to spread the reduction in a total maintenance cost and the change of a business model to other business models, the following cases are considered. As a first case, an organization or a worker who manages the core module in common is defined. For example, an organization which manages the core module in common may perform common management beyond an organization configuration of business, but determination of whether or not the common management is to be performed is preferably performed by each worker in consideration of management authority. As a second case, a structure of the core module is defined. For example, a range including a structure of the core module in a business model is preferably set through a conference between respective workers who perform common management. As a third case, it is determined whether or not a change of the core module is spread to other business models. For example, in a case where the core module is changed, determination of whether or not the change is accepted is preferably performed by each worker related to common management. As a fourth case, timing of determination performed by a worker is set. For example, if timing of each determination performed by a worker is late, business models become diversified, and thus commonalization conference is difficult. As a fifth case, timing for pulling out (extracting) core modules (common portions) themselves defining a structure of the core module is set. For example, in a case where there are common portions between a business model which is targeted by a certain template and a business model which is targeted by another template, the common portions are preferably pulled out.

Taking into consideration the above first to fifth cases, the following matters are preferably achieved. First, common portions of business models targeted by respective templates are pulled out (extracted) at appropriate timing and with an appropriate organization configuration. When a maintenance target business model is changed, a worker related to the maintenance target business model is requested to perform the determination.

Therefore, in the present embodiment, an apparatus which manages a business model includes the following functions. A first function is a function of performing generation management of a template (targeting a business model) by using a difference module. A second function is a function of performing adjustment so that common portions are pulled out at appropriate timing based on at least one of a relationship of generation and similarity of a business model. A third function is a function of spreading change content to other business models based on a predetermined determination (for example, a determination performed in advancing business) when a common portion is changed.

In other words, in the present embodiment, when a worker performs business in an environment (business environment) in which the business is performed by using a business model, business model update for business improvement is performed or improvement is promoted without increasing a total maintenance cost of a business model. For this reason, in the present embodiment, a range or a portion of business models which are managed in common by a plurality of workers is adjusted based on an adoption relationship and similarity of each business model, and each determination performed by a worker.

The present embodiment includes processes on a worker side in which a series of processes from business model creation to business execution is performed by using the terminal apparatus 90, and processes on a server side in which processes related to business improvement are performed by using the server apparatus 30. Examples of the processes related to business improvement include respective processes in recommendation of a difference module, a proposal of templating, a proposal to track a change, and a proposal of commonalization. Details of the processes will be described later. The processes on a worker side are performed in an environment in which business is performed, and include respective processes in creation, registration and execution of a business model, and processes performed according to the processes related to business improvement.

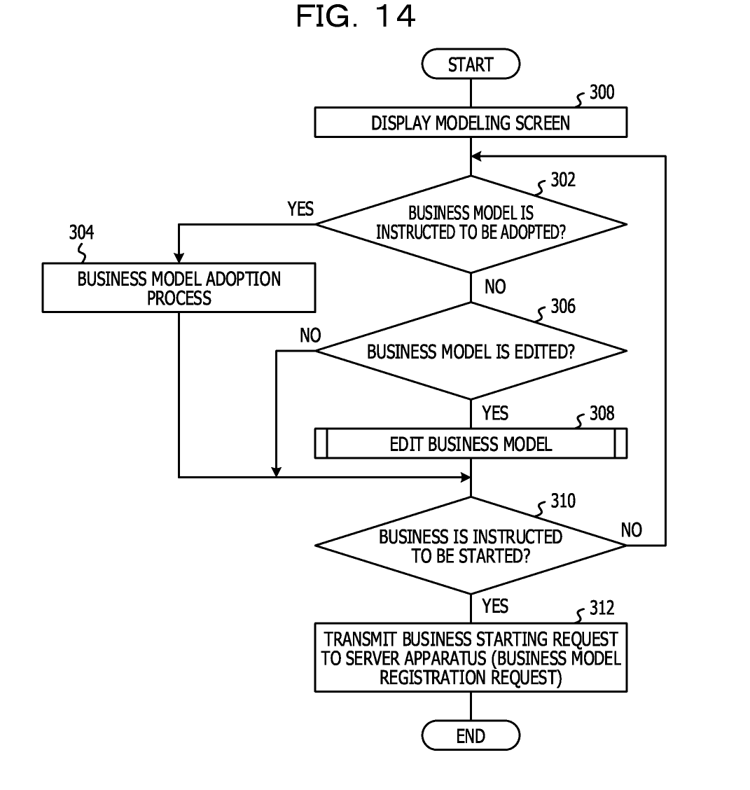

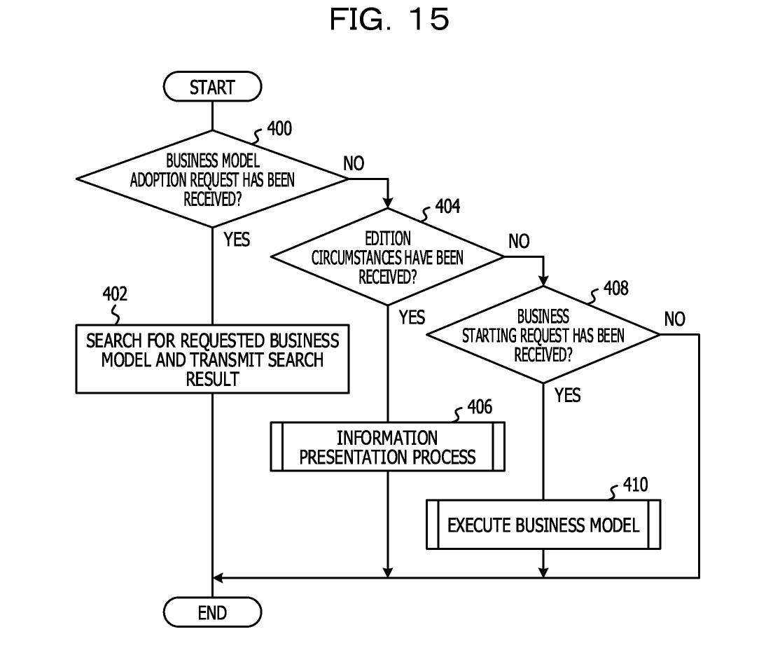

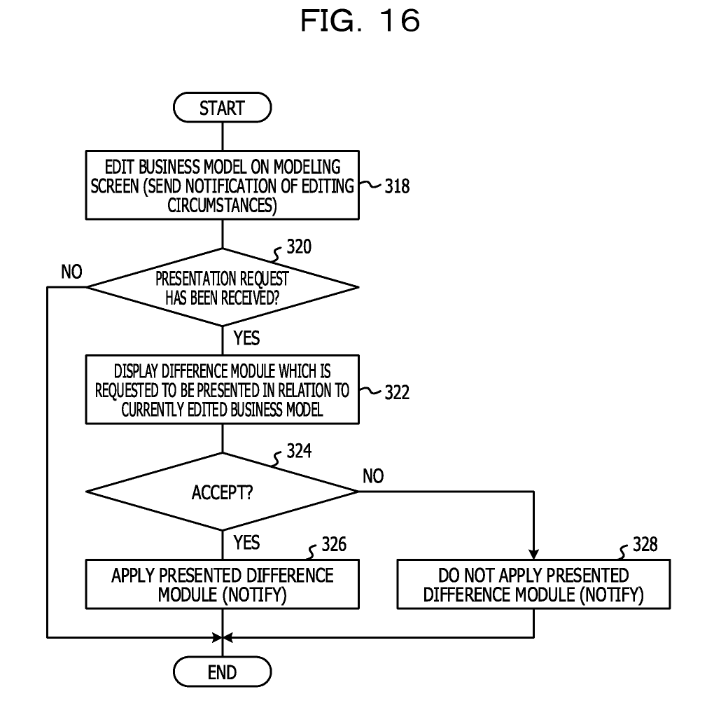

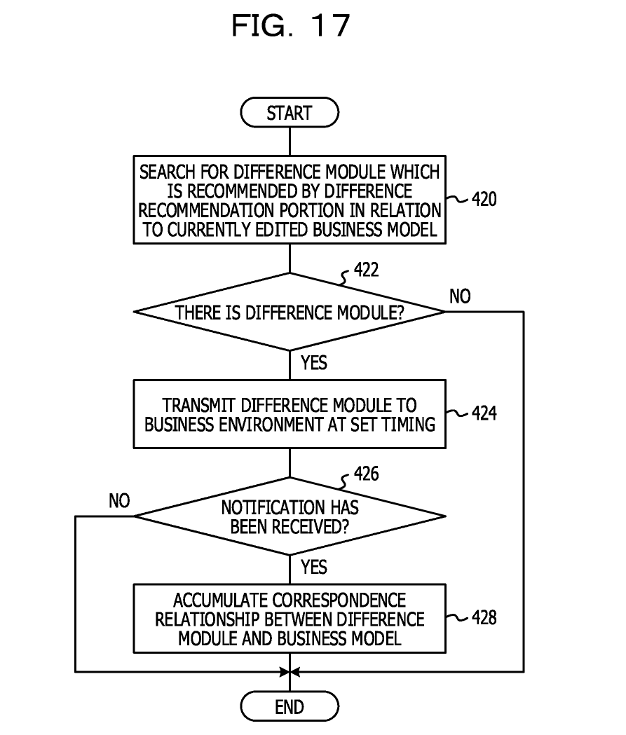

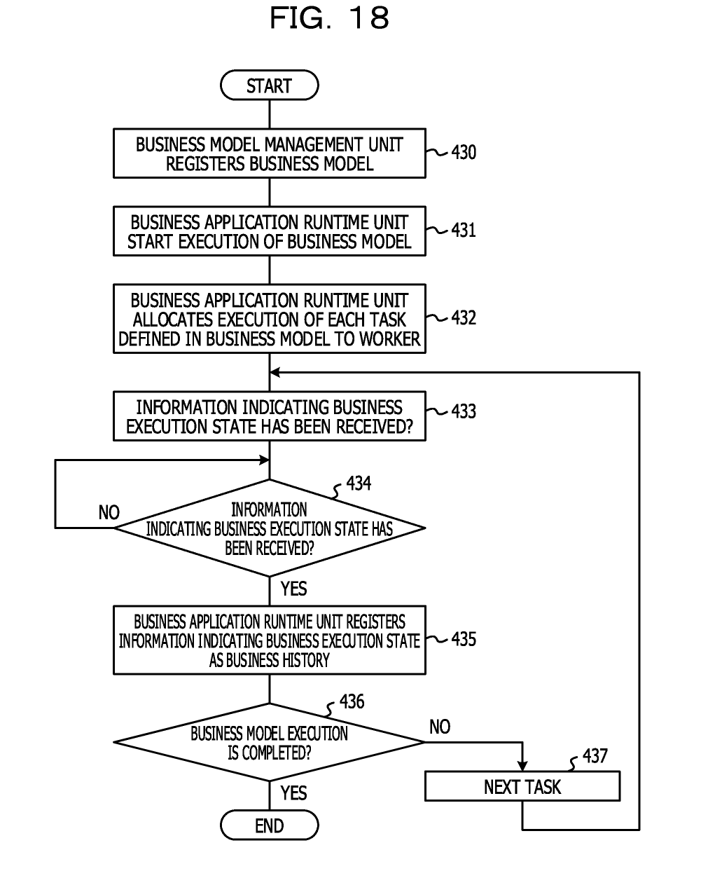

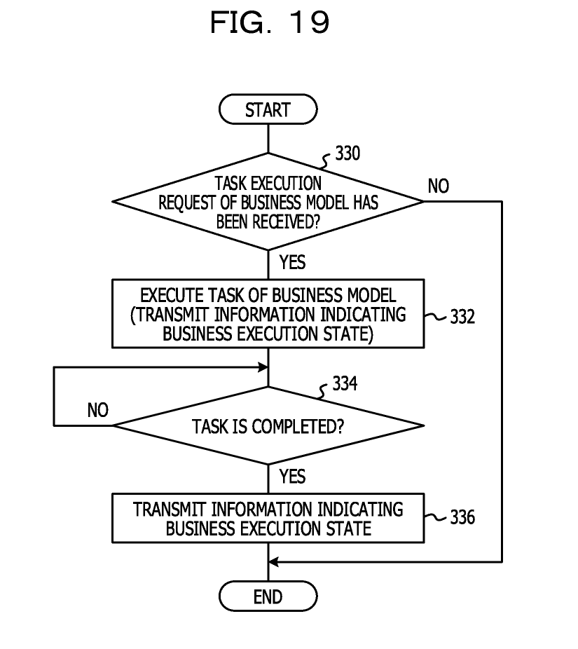

FIG. 14 illustrates an example of a flow of the process on a worker side, and FIG. 15 illustrates an example of a flow of the process on a server side. FIG. 16 illustrates a specific example of a flow of a business model editing process performed as the process on the worker side. As the process performed on the server side, FIG. 17 illustrates an example of an information presenting process, and FIG. 18 illustrates an example of a flow of a business model execution process. FIG. 19 illustrates a specific example of a flow of a business model execution process performed as the process on the worker side.

As illustrated in FIG. 14, in step S300, the CPU 91 of the terminal apparatus 90 of the worker side displays the modeling screen 220 (FIG. 11) on the display unit 95. In other words, when starting business, the worker 140 operates the terminal apparatus 90 so as to give an instruction for displaying the modeling screen 220, and thus the CPU 91 displays the modeling screen 220 (FIG. 11) on the display unit 95. Next, in step S302, the CPU 91 determines whether the search button 236 or the adoption button 240 is pressed on the modeling screen 220, and thus it is determined whether or not an instruction for a search for or adoption of a business model (or a business model targeted by a template) is given.

If the adoption button 240 is pressed and thus an instruction for adoption of a business model is given, the CPU 91 performs an affirmative determination in step S302, performs a business model adoption process in step S304, and then makes the process proceed to step S310. The business model adoption process in step S304 includes a process of requesting an existing business model (or a business model targeted by a template) to be adopted and a process of requesting a search for an adoption target business model for adopting an existing business model. In other words, in the business model adoption process, information regarding the adoption target business model is transmitted to the server apparatus 30.

In a case where the search is requested, for example, the worker inputs text information such as a keyword to the display region 234 of the modeling screen 220 through an input operation of the terminal apparatus 90 and presses the search button 236. If the search button 236 is pressed, the CPU 91 transmits the input text information to the server apparatus 30 as search information for adoption of a business model. The server apparatus 30 searches for a business model targeted by a registered template, and transmits the business model which is a search result so as to be selectable as an adoption candidate business model (refer to FIG. 15). The CPU 91 displays the adoption candidate business model which is a search result transmitted from the server apparatus 30 so as to be selectable (step S304). The worker selects and indicates a business model to be adopted from among displayed adoption candidate business models through an input operation of the terminal apparatus 90 and presses the adoption button 240. In other words, in a case where adoption is requested, the CPU 91 detects pressing of the adoption button 240, and transmits information (for example, information including an identifier of the business model) indicating the adopted business model to the server apparatus 30 as information indicating an adoption request. The server apparatus 30 receives the information indicating the business model of which an adoption request is made, and returns the corresponding business model. The CPU 91 receives the information indicating the business model, returned from the server apparatus 30, and displays the business model in the display region 226 of the modeling screen 220 in an editable manner.

On the other hand, if the adoption button 240 is not pressed, the CPU 91 performs a negative determination in step S302, and determines whether or not a business model editing process is to be performed in step S306. Whether or not the business model editing process is to be performed is determined by determining whether or not information has been input to the input window (either the display region 222 or the display region 226) of the modeling screen 220 or displayed information has been changed through an input operation by the worker. If a negative determination is performed in step S306, the CPU 91 makes the process proceed to step S310, and if an affirmative determination is performed, the CPU 91 performs the business model editing process (which will be described later in detail) in step S308 and makes the proceed to step S310. In addition, in the business model editing process in step S308, information indicating business model editing circumstances is transmitted to the server apparatus 30.

Next, the CPU 91 determines whether or not the execution button 224 on the modeling screen 220 is pressed in step S310 and thus determines whether or not execution of business is instructed to be started, and returns to step S302 if a negative determination is performed. On the other hand, if an affirmative determination is performed in step S310, the CPU 91 makes the process proceed to step S312 and transmits information indicating that business execution starting based on a business model is requested, to the server apparatus 30. In other words, the worker 140 presses the execution button 224 on the modeling screen 220 (FIG. 11) of the business environment and thus requests the server apparatus 30 to start execution of the business.

On the other hand, in the server apparatus 30, a process routine illustrated in FIG. 15 is periodically executed, so that the information transmitted from the terminal apparatus 90 of the worker side is detected, and a process corresponding to a detection result is performed. First, in step S400, the CPU 32 of the server apparatus 30 determines whether or not search information indicating a business model adoption request or information indicating an adoption request has been received. If an affirmative determination is performed in step S400, the CPU 32 proceeds to step S402. If the search information has been received, a requested business model is searched for, and the search result is returned to the terminal apparatus 90 of the worker side. In step S402, if the information indicating an adoption request has been received, information indicating a corresponding business model is returned.

If a negative determination is performed in step S400, the CPU 32 proceeds to step S404 and determines whether or not information indicating business model editing circumstances has been received. If an affirmative determination is performed in step S404, the CPU 32 proceeds to step S406 and performs an information presenting process. Details of the process will be described later. If a negative determination is performed in step S404, the CPU 32 proceeds to step S408 and determines whether or not the information indicating that business execution starting based on a business model is requested has been received. If a negative determination is performed, the present process routine is finished. On the other hand, if an affirmative determination is performed in step S408, the CPU 32 performs a process using the business model based on the information from the terminal apparatus 90. Details of the process will be described later.

Next, a further description will be made of the business model editing process of the worker side in step S308 illustrated in FIG. 14. In step S308 illustrated in FIG. 14, a process routine illustrated in FIG. 16 is executed. The business model editing process of the worker side includes a process of the business model editing process itself in step S318, and an acceptance process of accepting presentation of information related to a currently edited business model in steps S320 to S328. In the process of the business model editing process itself in step S318, the CPU 91 performs the business model editing process. In other words, the worker 140 operates the terminal apparatus 90 so as to edit at least part of a business model. In step S318, the CPU 91 acquires information which is input through an input operation of the terminal apparatus 90 by the worker or information indicating an operation result and thus acquires information business model editing circumstances. In step S318, the CPU 91 transmits information indicating the acquired business model editing circumstances to the server apparatus 30 so as to send a notification of the business model editing circumstances.

In the server apparatus 30, in order to correspond to the process of the business model editing process itself of the worker side, the difference recommendation portion 112 of the improvement control unit 104 receives the notification of the business model editing circumstances sent from the terminal apparatus 90 via the interaction unit 100 in step S404 illustrated in FIG. 15. In other words, in the server apparatus 30, if the information indicating the business model editing circumstances has been received, the CPU 32 performs an affirmative determination in step S404 illustrated in FIG. 15, and performs an information presentation process in step S406. In the information presentation process in step S406 illustrated in FIG. 15, a process routine illustrated in FIG. 17 is executed.

As illustrated in FIG. 17, if the information indicating the business model editing circumstances is received from the terminal apparatus 90 of the worker side, the CPU 32 of the server apparatus 30 searches for a difference module which is recommended to the worker side which is currently editing a business model in step S420. In other words, as a difference module presented to the worker side, the difference recommendation portion 112 searches for a difference module which is recommended by the difference recommendation portion 112. Next, the CPU 32 determines whether or not there is a difference module in a search result. If an affirmative determination is performed in step S422, the CPU 32 makes the process proceed to step S424, and transmits information indicating the difference module of the difference module of the search result to the terminal apparatus 90 as information indicating a difference module which is recommended to the worker side. In other words, the difference recommendation portion 112 of the improvement control unit 104 transmits the information indicating a recommended difference module to the terminal apparatus 90 in order to present a difference module which is recommended as a difference module which is applicable to a currently edited business model on the worker side, to the worker side. In addition, the difference recommendation portion 112 transmits information indicating a request for presenting the recommended difference module, to the terminal apparatus 90.

In the terminal apparatus 90 of the worker side, an acceptance process of information from the server apparatus 30 is performed. In other words, in step S320 illustrated in FIG. 16, the CPU 91 determines whether or not the information indicating a request for presenting the difference module, transmitted from the server apparatus 30, has been received. If a negative determination is performed in step S320, the CPU 91 finishes the present process routine. On the other hand, if an affirmative determination is performed in step S320, the CPU 91 displays the difference module which is requested to be presented from the server apparatus 30 in step S322. Next, in step S324, the CPU 91 determines whether or not applying the displayed difference module to the currently edited business model has been accepted based on information indicating an operation of the input unit 96 of the terminal apparatus 90 by the worker.

If an affirmative determination is performed in step S324, the CPU 91 applies the presented difference module to the currently edited business model in step S326 and then finishes the present process routine. In step S326, the CPU 91 notifies the server apparatus 30 of information (acceptance information) indicating that the recommended difference module has been accepted by the worker 140. In the server apparatus 30, if the difference management unit 120 of the improvement control unit 104 receives a notification including the acceptance information sent from the terminal apparatus 90 via the interaction unit 100 (if an affirmative determination is performed in step S426 illustrated in FIG. 17), information indicating a correspondence relationship between the difference module and the business model is accumulated. In other words, the difference management unit 120 accumulates the information indicating a correspondence relationship between the accepted difference module and the business model in the difference applying DB 82 in step S428 illustrated in FIG. 17.

On the other hand, if a negative determination is performed in step S324, the CPU 91 does not apply the difference module to the currently edited business model and notifies the server apparatus 30 of information (refusal information) indicating that the recommended difference module is not accepted by the worker 140 in step S328. In the server apparatus 30, if the difference management unit 120 of the improvement control unit 104 receives a notification including the refusal information sent from the terminal apparatus 90 via the interaction unit 100 (if a negative determination is performed in step S426 illustrated in FIG. 17), the difference management unit 120 finishes the present process routine as it is.

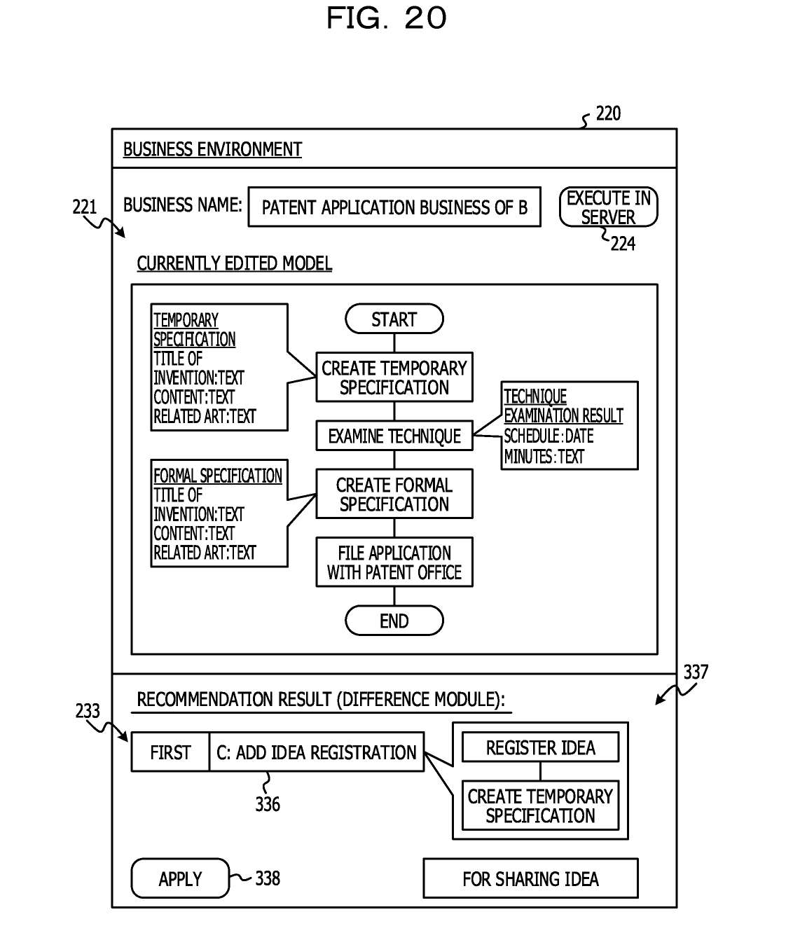

FIG. 20 illustrates an example of the modeling screen 220 in a case where a difference module is recommended. Information indicating a recommended difference module is displayed in the display region 233 for displaying support information in the modeling screen 220 illustrated in FIG. 20. Specifically, the display region 233 includes a display region 336 for displaying information indicating a difference module which is a recommendation result, and a display region 337 for displaying image information related to the difference module. The display region 336 is also used as an input window which allows one of displayed difference modules which are recommendation results to be designated through an input operation of the terminal apparatus 90 by the worker. In addition, the display region 233 also includes an applying button 338 for giving an instruction for applying a difference module to a business model. Therefore, after one of the displayed difference modules which are recommendation results is designated, the CPU 91 determines whether or not the applying button 338 is pressed and may thus perform the determination process in step S324.

Next, a process related to business execution performed by the worker will be described more in detail. In the business model execution process (step S410 illustrated in FIG. 15) of the server apparatus 30 side, a process routine illustrated in FIG. 18 is executed. In the process using a business model of the worker side, a process routine illustrated in FIG. 19 is executed.

In the server apparatus 30, if information indicating a request for starting business execution is received from the terminal apparatus 90, business of a business model is performed by the business application runtime unit 114. In other words, in step S312 (FIG. 14) of the worker side, information indicating a business model of which an editing process is completed is transmitted to the server apparatus 30, and, in the server apparatus 30, information indicating the created business model is updated via the business model management unit 116. In other words, in the server apparatus 30, if the interaction unit 100 receives the information indicating a request for starting business execution from the terminal apparatus 90, in step S430 illustrated in FIG. 18, the business model management unit 116 registers the edited business model in the business model DB 74. Next, the business application runtime unit 114 starts execution of the business model in step S431. The business application runtime unit 114 allocates execution of each item of work (task) defined in the business model to each worker in step S432, and transmits a request for executing the task of the business model to the terminal apparatus 90 in the subsequent step S433. The worker executes the allocated work (task). Details thereof will be described later. Information indicating business execution states such as an execution state of the business, time, and input data in each task is sequentially transmitted to the server apparatus 30 from the worker side. If the information indicating the business execution states is received, the business application runtime unit 114 performs an affirmative determination in step S434, and accumulates the information indicating the business execution states in the business history DB 72 in step S435. Next, the business application runtime unit 114 determines whether or not processes of all tasks of the business model are completed, and finishes the present process routine if an affirmative determination is performed. On the other hand, if a negative determination is performed in step S436, the business application runtime unit 114 makes the process proceed to the next task of the business model in step S437, and returns to step S433.

On the other hand, on the worker side, the process routine illustrated in FIG. 19 is periodically executed, and the CPU 91 of the terminal apparatus 90 determines whether or not a request for executing a task of the business model has been received in step S330, and finishes the present process routine if a negative determination is performed. If an affirmative determination is performed in step S330, the CPU 91 notifies the worker of execution of a task via the business execution screen 200 in step S332. If the worker performs work based on the task of which a notification has been sent, the worker inputs various information pieces to the input window (the display region 201) through an input operation of the terminal apparatus 90. In step S332, during the execution of the task, information input through an operation of the terminal apparatus 90 by the worker or information indicating an operation result may be acquired, and may be transmitted to the server apparatus 30 as information indicating a business execution state. Next, the CPU 91 determines whether or not the next work button 204 is pressed in step S334 and thus determines whether or not the task is completed, and waits until an affirmative determination is performed. If an affirmative determination is performed in step S334, the CPU 91 acquires information input through an operation of the terminal apparatus 90 by the worker or information indicating an operation result in step S336, and transmits the information to the server apparatus 30 as information indicating a business execution state.

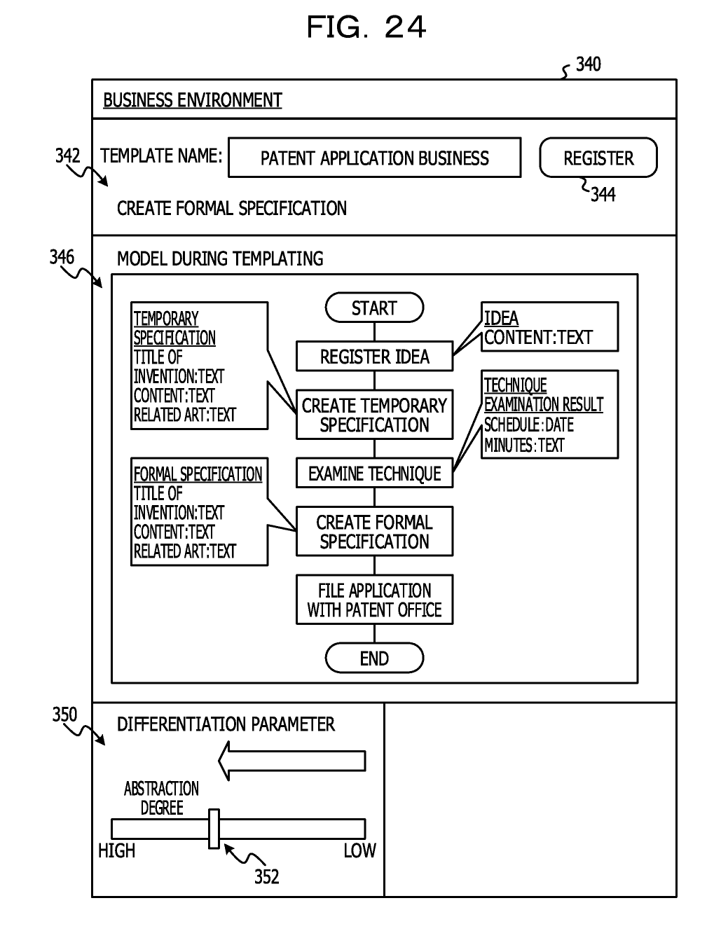

In the terminal apparatus 90 of the worker side, after the process in step S312 illustrated in FIG. 14, the template management screen 270 may be displayed, and a process of registering an edited business model as a template may be added if the registration button 278 is pressed. In other words, the worker 140 may give any name to a business model of which a use frequency is predicted to be increased in the future and register the business model as a template by using the template management screen 270 (FIG. 13) from the business environment. In the present embodiment, a name of a template is fixed, and a reference destination business model is changed to another business model, so as to allow a change of the business model to be tracked. In addition, information indicating a template is accumulated in the template DB 76 by the template management unit 118 of the server apparatus 30. After the registration button 278 is pressed, a screen may transition from the template management screen 270 to a template creation screen 340 (refer to FIG. 24 which will be described later). The template creation screen 340 is used to give an instruction for information for determining a template in detail.

Next, a description will be made of an example of business model update for business improvement or an improvement proposal to promote improvement as presentation of information related to a currently edited business model. In the above description, in the acceptance process (steps S320 to S328) of the business model editing process of the worker side, a description has been made of an example in which a difference module recommended by the server side, related to an currently edited business model and transmitted from the server apparatus 30, is accepted. Herein, a description will be made of business model update for business improvement or an improvement proposal to promote improvement.

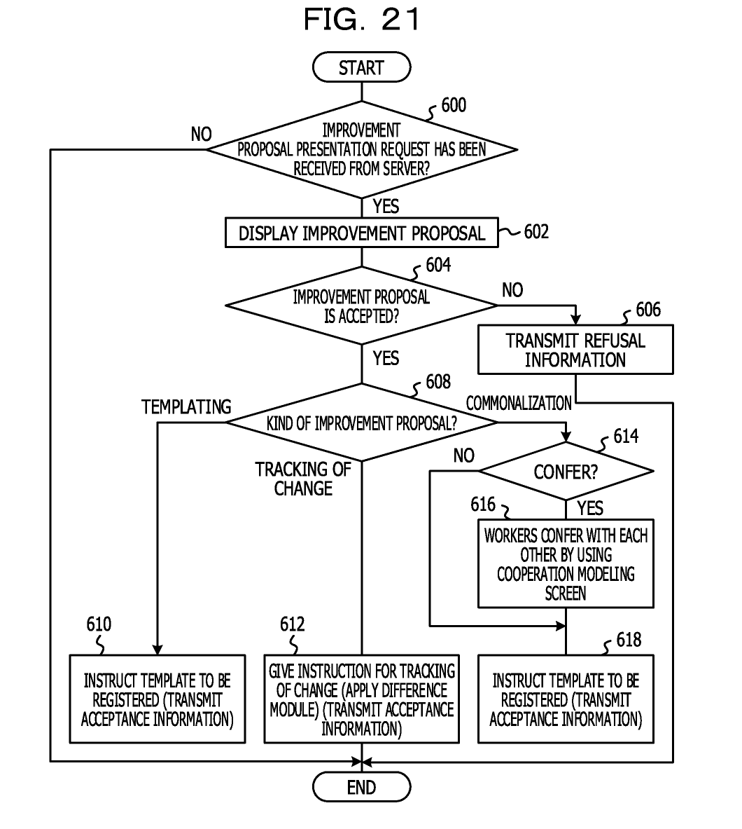

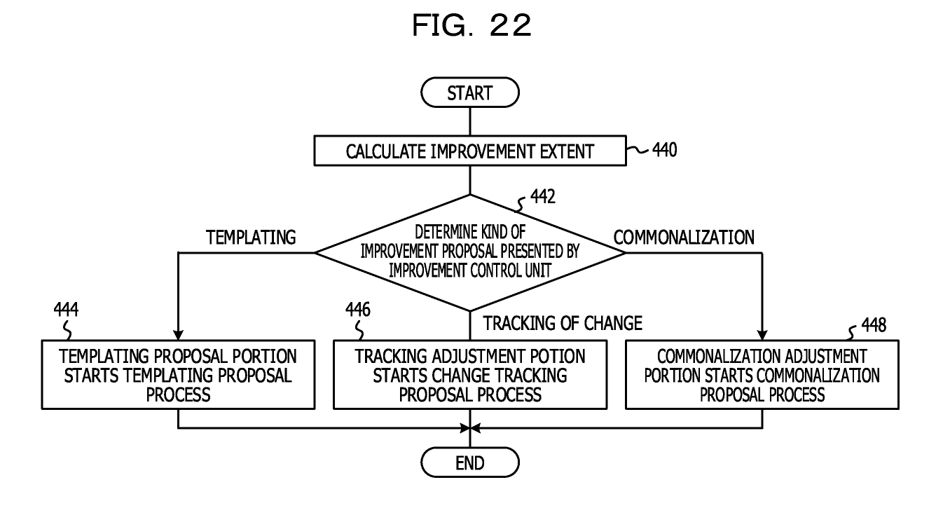

The business model update for business improvement or the process of promoting improvement, performed on the worker side, may be realized by replacing an improvement proposal with recommendation of the above-described difference module. Specifically, an improvement proposal accepting process is performed in the acceptance process (steps S320 to S328 illustrated in FIG. 16) of the business model editing process on the worker side. FIG. 21 illustrates an example of a flow of the improvement proposal accepting process. In addition, in the server apparatus 30, an improvement proposal process is performed in the information presentation process in step S406 illustrated in FIG. 15. FIG. 22 illustrates an example of a flow of the improvement proposal process.

In the present embodiment, as examples of the improvement proposal process performed by the server apparatus 30, a “proposal of templating”, a “proposal to track a change”, and a “proposal of commonalization” are used. Details thereof will be described later. The “proposal of templating” indicates an improvement proposal of making a proposal indicating that a currently edited business model is templated. The “proposal to track a change” indicates an improvement proposal of making a proposal indicating that, when a currently edited business model is changed, other business models or templates track the change. The “proposal of commonalization” indicates an improvement proposal of making a proposal indicating that a common portion between a currently edited business model and another business model or a business model targeted by a template is commonalized.

In the server apparatus 30, if the CPU 32 receives the information indicating business model editing circumstances (if an affirmative determination is performed in step S404 illustrated in FIG. 15), a process routine illustrated in FIG. 22 is performed as the information presentation process in step S406. First, in the server apparatus 30, the CPU 32 calculates an improvement extent in step S440. The improvement extent is obtained for each of the “proposal of templating”, the “proposal to track a change”, and the “proposal of commonalization”.

An improvement extent of the “proposal of templating” is obtained by the templating proposal portion 106 (FIG. 3). The templating proposal portion 106 analyzes various information pieces accumulated in the DB 70, predicts a reuse possibility of a business model corresponding to the received information indicating the editing circumstances, and uses a prediction result as the improvement extent. The analyzed various information pieces are information pieces which are respectively accumulated in the business model DB 74, the template DB 76, the business history DB 72, the difference DB 80, and the difference applying DB 82, included in the DB 70. For example, information indicating a reuse possibility of the business model has a difference value between a currently edited business model and another business model as a prediction value. In a case where another business model is adopted, a prediction value may be a difference value between the adoption source business model and a currently edited business model.

An improvement extent of the “proposal to track a change” is obtained by the tracking adjustment potion 110 (FIG. 3). The tracking adjustment potion 110 analyzes the various information pieces accumulated in the DB 70, predicts the validity in tracking a change of an adoption source with respect to a business model of which a template which is the adoption source is changed, and uses a prediction result as the improvement extent. The analyzed various information pieces are information pieces which are respectively accumulated in the business model DB 74, the template DB 76, the business history DB 72, the difference DB 80, and the difference applying DB 82, included in the DB 70. For example, a prediction value may be the number of workers which adopts a business model corresponding to received information indicating editing circumstances.

An improvement extent of the “proposal of commonalization” is obtained by the commonalization adjustment portion 108. The commonalization adjustment portion 108 analyzes the various information pieces accumulated in the DB 70, predicts the validity in pulling out a common portion from other business models among templates having a structure similar to that of a currently edited business model, and uses a prediction result as the improvement extent. The analyzed various information pieces are information pieces which are respectively accumulated in the business model DB 74, the template DB 76, the business history DB 72, the difference DB 80, and the difference applying DB 82, included in the DB 70. For example, it is valid that a business model has a common portion, and a prediction value may be a size of a common portion between a currently edited business model and another business model or a template.

In the server apparatus 30, in step S442, the CPU 32 determines which improvement proposal is performed among the “proposal of templating”, the “proposal to track a change”, and the “proposal of commonalization” according to the calculated improvement extent. In addition, in order to avoid overlapping of the competitive improvement proposals, in step S442, the improvement control unit 104 may give priority to the kind of improvement proposal and may perform the determination. The priority may be set to each kind of improvement proposal in advance so that an improvement proposal is prioritized as the given priority is increased.

In the server apparatus 30, if the improvement control unit 104 determines that the kind of improvement proposal is the “proposal of templating”, the templating proposal portion 106 starts a templating proposal process in step S444. If the improvement control unit 104 determines that the kind of improvement proposal is the “proposal to track a change”, the tracking adjustment potion 110 starts a change tracking proposal process in step S446. If the improvement control unit 104 determines that the kind of improvement proposal is the “proposal of commonalization”, the commonalization adjustment portion 108 starts a commonalization proposal process in step S448.

The improvement proposal preferably includes a countermeasure so that a load on the worker 140 who is currently performing business is not increased, and the business is not hindered. When the improvement proposal is made, examples of the countermeasure include a countermeasure for following a proposal method of the improvement proposal, and a countermeasure for setting timing at which the improvement proposal is made. As examples of the countermeasure for following a proposal method, there is a method in which information for a pop-up notification at a screen corner of the business environment 130 is received from the interaction unit 100, or a method in which an e-mail is transmitted to an e-mail address of the worker 140 from the server apparatus 30. As the countermeasure for setting timing in which the improvement proposal is made, there is a countermeasure which is made at preset timing in a business process using a business model. As an example of the set timing, there is the time when a business process using a business model is finished, the time when a business process is temporarily resolved (for example, there is no allocation of business including work right before the due date), or an off-period of business (for example, end of term is avoided). The countermeasure when the improvement proposal is made may be set in each portion of the interaction unit 100 and the improvement control unit 104. A set value of the countermeasure when the improvement proposal is made may be set through determinations in the interaction unit 100 and the improvement control unit 104, and may be set individually by a worker or a use organization. A timing control portion which controls set timing may be provided in the improvement control unit 104 so as to perform control.

Next, a description will be made of the process of the “proposal of templating” performed in step S444 (FIG. 22).

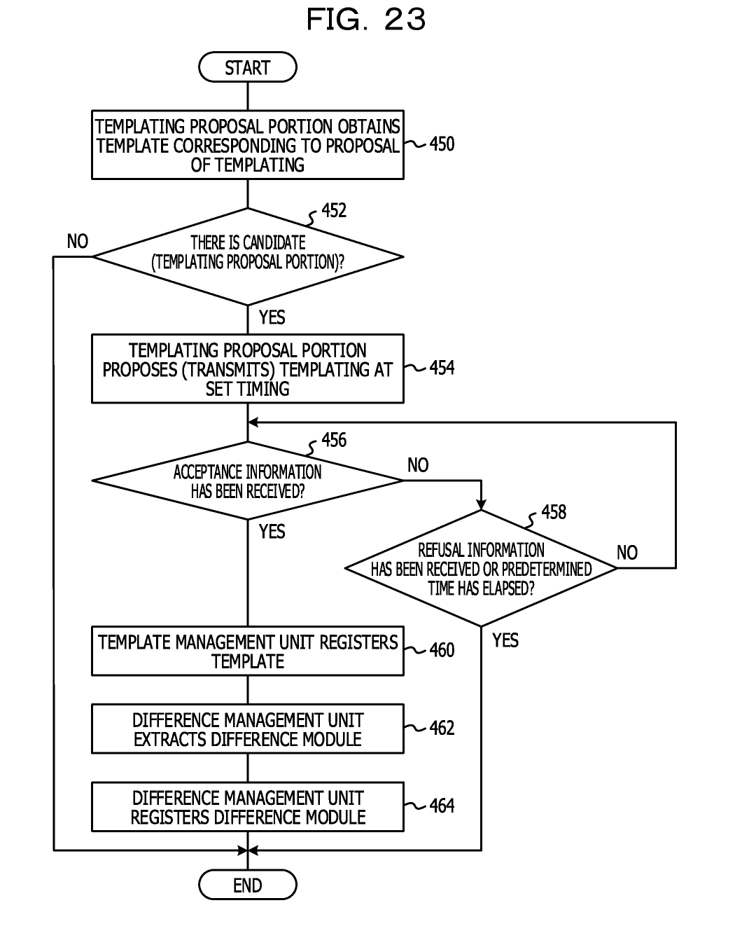

FIG. 23 illustrates an example of a process related to the templating proposal in the server apparatus 30. First, in step S450, the templating proposal portion 106 obtains a business model or a template which is a candidate for proposing templating. Next, in step S452, the templating proposal portion 106 determines whether or not there is a business model which is a candidate, and finishes the present process routine if a negative determination is performed, and makes the process proceed to step S454 if an affirmative determination is performed.

A business model which is a candidate for proposing templating is preferably selected according to a purpose of the organization or appropriately. As an example of the selection of a business model, a business model created when a new business process is performed may be selected. For example, among business models which are newly created without adopting other business models and with which a business process is performed, a business model based on similarity such as a difference from existing other business models being equal to or larger than a predefined specific value is selected as a business model which is a candidate for proposing templating. As another example of the selection of a business model, a business model which is created by adopting an existing template and is thus improved may be selected. For example, a business model which adopts an existing template and is based on similarity such as a difference from the adoption source being equal to or larger than a predefined specific value is selected as a business model which is a candidate for proposing templating.

Next, the templating proposal portion 106 proposes templating in step S454. In other words, information indicating a templating proposal is transmitted to the terminal apparatus 90. On the worker side, acceptance information indicating that the proposed templating is accepted or refusal information indicating refusal thereof is transmitted according to the information indicating the templating proposal. Details thereof will be described later.

In the server apparatus 30, in step S456, the improvement control unit 104 determines whether or not the information indicating that the proposed templating is accepted has been received from the terminal apparatus 90, and the process proceeds to step S460 if an affirmative determination is performed. On the other hand, if a negative determination is performed in step S456, it is determined whether or not the information indicating that the proposed templating is refused has been received from the terminal apparatus 90 or a predetermined time has elapsed in step S458. If a negative determination is performed in step S458, the process returns to step S456, and if an affirmative determination is performed, the present process routine is finished without registering the templating.

On the other hand, if an affirmative determination is performed in step S456, the template management unit 118 registers information indicating the proposed templating in the template DB 76 in step S460. In step S462, the difference management unit 120 extracts a difference module from a business model which is a templating target which is proposed and registered, and, in step S464, the difference module is registered in the difference DB 80. Then, the present process routine is finished.

FIG. 21 illustrates the improvement proposal accepting process performed on the worker side.

The terminal apparatus 90 of the worker side performs a process of accepting the information indicating a templating proposal from the server apparatus 30. In other words, the CPU 91 determines whether or not information indicating a request for presenting the improvement proposal has been received from the server apparatus 30 in step S600 illustrated in FIG. 21. If a negative determination is performed in step S600, the CPU 91 finishes the present process routine. On the other hand, if an affirmative determination is performed in step S600, the CPU 91 displays the information presenting the improvement proposal requested from the server apparatus 30 in step S602. Next, in step S604, the CPU 91 determines whether or not the displayed information presenting the improvement proposal has been accepted based on information indicating an operation of the input unit 96 of the terminal apparatus 90 by the worker.

If an affirmative determination is performed in step S604, the CPU 91 discriminates the kind of improvement proposal in step S608. Here, the templating is selected as the kind of improvement proposal, and the process proceeds to step S610. In step S610, information indicating a template based on the templating of which improvement is proposed is instructed to be registered, and the server apparatus 30 is notified of information indicating that the improvement proposal has been accepted by the worker 140. On the other hand, if a negative determination is performed in step S604, the CPU 91 transmits refusal information indicating that the improvement proposal is not accepted by the worker 140 to the server apparatus 30 in step S606, and finishes the present process routine.

Here, the template creation screen 340 will be further described. The template creation screen 340 is used to give an instruction for information for determining a template in detail.

FIG. 24 illustrates an example of the template creation screen 340. The template creation screen 340 includes a display region 342, including a registration button 344, for displaying information indicating a template, a display region 346 for displaying image information of a templated business model, and a display region 350. The display region 350 is a display region including an adjustment bar 352 for adjusting an abstraction degree of a templated business model. The display region 350 is also used as an input window for moving a position of the adjustment bar 352 in order to adjust an abstraction degree of a differentiation parameter through an input operation of the terminal apparatus 90 by the worker.

In the process related to the templating of a business model, a plurality of workers may adjust information by using a cooperation modeling screen of the business environment, and may give instructions for various information pieces in the terminal apparatus 90.

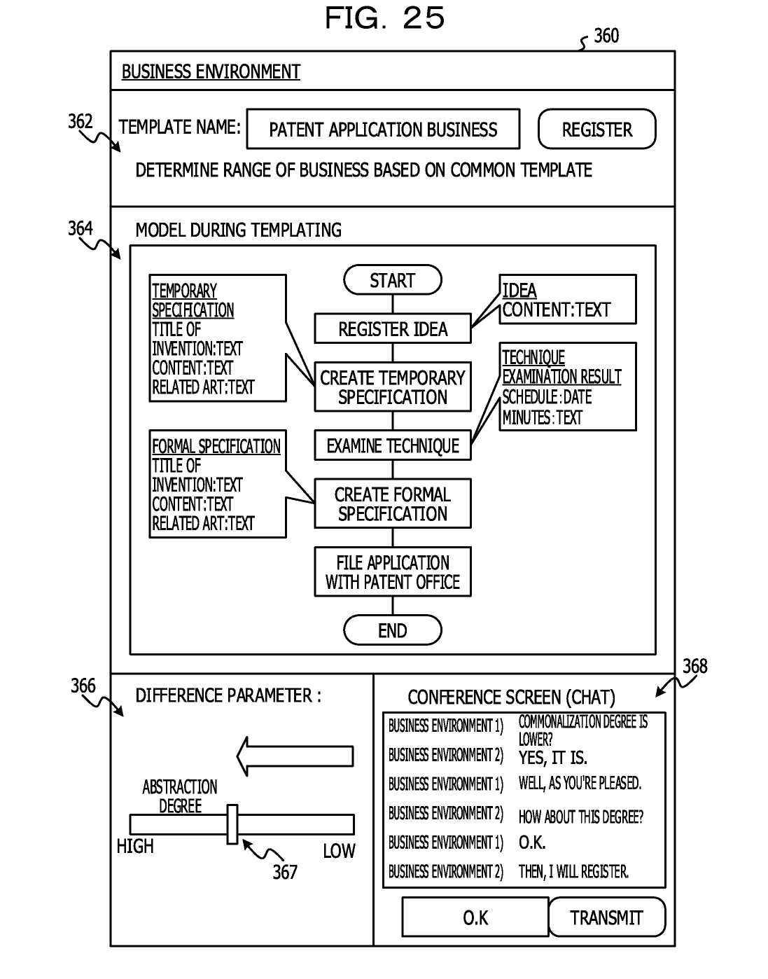

FIG. 25 illustrates an example of a cooperation modeling screen 360 displayed on the worker side in the process related to the templating of a business model. In the process related to the templating of a business model, instructions for various information pieces may be given in the terminal apparatus 90 by using the cooperation modeling screen 360 of the business environment. The cooperation modeling screen 360 is obtained by adding a display region 368 such as the display region 251 for displaying information shared between a plurality of workers on the cooperation modeling screen 250, to the template creation screen 340. In other words, the cooperation modeling screen 360 includes a display region 362 such as the display region 342 illustrated in FIG. 24 and a display region 364 such as the display region 346 illustrated in FIG. 24. The cooperation modeling screen 360 includes a display region 368 such as the display region 251 including the display region 258, the display region 260, and the transmission button 262 illustrated in FIG. 12. The display region 366 is also used as an input window for moving a position of an adjustment bar 367 in order to adjust an abstraction degree of a templating parameter through an input operation of the terminal apparatus 90 by the worker.

In other words, on the template creation screen 340, a structure of a business model registered as a template may be edited, and the business model may be registered with a name. On the cooperation modeling screen 360, a structure of a business model registered as a template may be edited, and the business model may be registered with a name, in cooperation between a plurality of workers.

Next, a further description will be made of the process of the “proposal to track a change” performed in step S446 (FIG. 22).

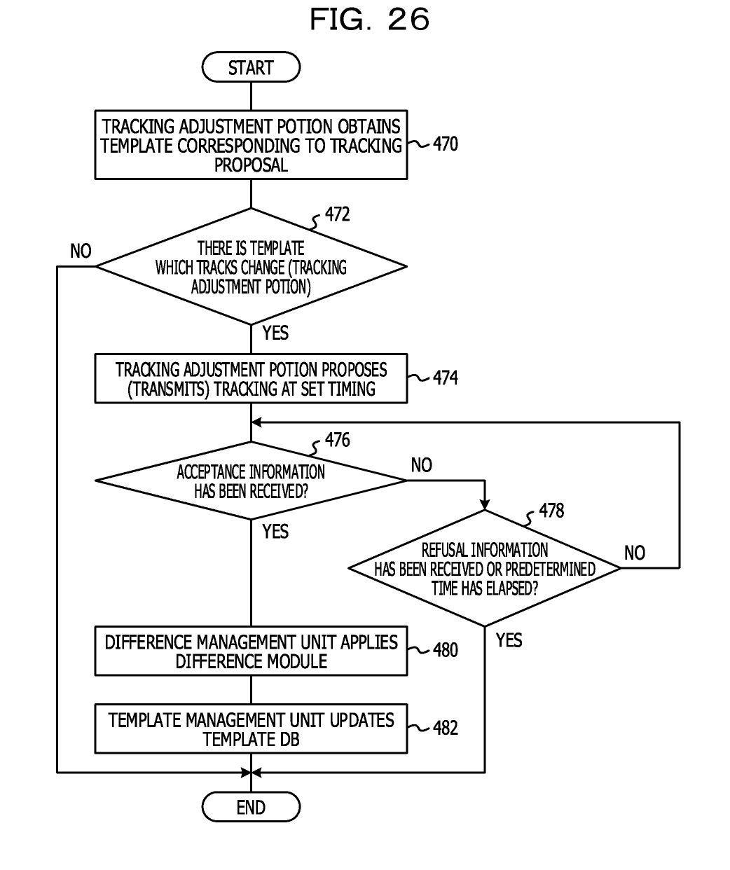

FIG. 26 illustrates an example of a process related to the proposal to track a change of a template in the server apparatus 30. First, the tracking adjustment potion 110 (FIG. 3) obtains a candidate business model or template which tracks a change of a currently edited business model in step S470. Next, the tracking adjustment potion 110 determines whether or not there is a candidate business model in step S472, and finishes the present process routine if a negative determination is performed, and makes the process proceed to step S474 if an affirmative determination is performed.

A candidate business model which tracks a change is preferably selected according to a purpose of the organization or appropriately. As an example of the selection of a business model, with respect to a template of which a reference destination business model is updated by accepting a templating proposal, a business model which has an unupdated business model which is a reference destination of the template as an adoption source is selected as a candidate business model which tracks a change. In addition, a business model which is reachable by following adoption and is registered as a template by a certain worker is selected as a candidate business model which tracks a change. Next, in step S474, the tracking adjustment potion 110 proposes tracking of a change in relation to a business model whose change difference is smaller than a specific amount, or a business model based on similarity such as the same change being tracked by workers of which the number is equal to or larger than a specific number, at set timing. In other words, information indicating the change tracking proposal is transmitted to the terminal apparatus 90. On the worker side, acceptance information indicating that the proposed change tracking is accepted or refusal information indicating refusal thereof is transmitted according to the information indicating the change tracking proposal. Details thereof will be described later.

In the server apparatus 30, in step S476, the improvement control unit 104 determines whether or not the information indicating that the proposed change tracking is accepted has been received from the terminal apparatus 90, and the process proceeds to step S480 if an affirmative determination is performed. On the other hand, if a negative determination is performed in step S476, it is determined whether or not the information indicating that the proposed change tracking is refused has been received from the terminal apparatus 90, or a predetermined time has elapsed in step S478. If a negative determination is performed in step S478, the process returns to step S476, and if an affirmative determination is performed, the present process routine is finished without applying the change tracking.

On the other hand, if an affirmative determination is performed in step S476, the difference management unit 120 applies change tracking to a business model which is a change tracking target in step S480, and extracts a difference module in the business model which is a change tracking target and registers the difference module in the difference DB 80. In addition, the template management unit 118 updates the template DB 76 in step S460, and finishes the present process routine.

In the process related to tracking of a change of a business model, in the same manner as in the templating proposal process, in a case where determinations of a plurality of workers are applied, instructions for various information pieces may be given in the terminal apparatus 90 by using the cooperation modeling screen 360 (FIG. 25) of the business environment. In other words, on the cooperation modeling screen 360, a structure of a template having undergone the tracking is displayed and is instructed to be registered according to a determination of the worker, and thus the template DB 76 is updated via the template management unit 118. In the tracking of a change, a new template is accumulated in the template DB 76 via the template management unit 118, and the difference DB 80 and the difference applying DB 82 are also respectively updated.

On the other hand, in the terminal apparatus 90 of the worker side, in the improvement proposal accepting process for the change tracking, the CPU 91 discriminates the change tracking as the kind of improvement proposal in step S608 illustrated in FIG. 21, and makes the process proceed to step S612. In step S612, information indicating a difference module based on the change tracking of which improvement is proposed is instructed to be registered, information indicating that the improvement proposal has been accepted by the worker 140 is transmitted to the server apparatus 30, and then the present process routine is finished.

Here, a description will be made of a specific example of the proposal to track a change of a business model or a template. In addition, here, a description will be made of a case where a plurality of workers use a business model (or a template) which is created in advance. It is assumed that each of a worker A belonging to the patent management division and workers B and C belonging to different sections of the research and development division uses the business description management apparatus 10 which may be implemented with the computer system 11.

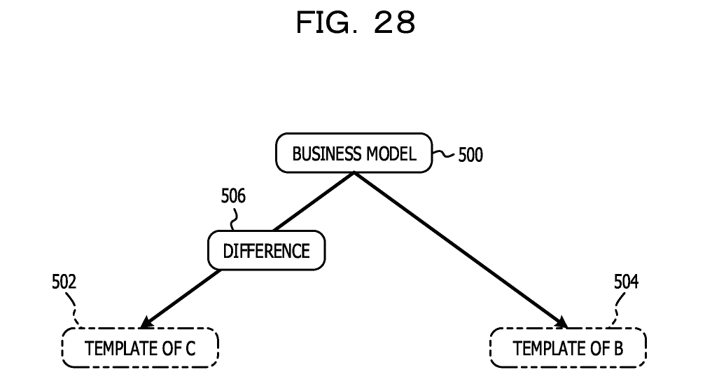

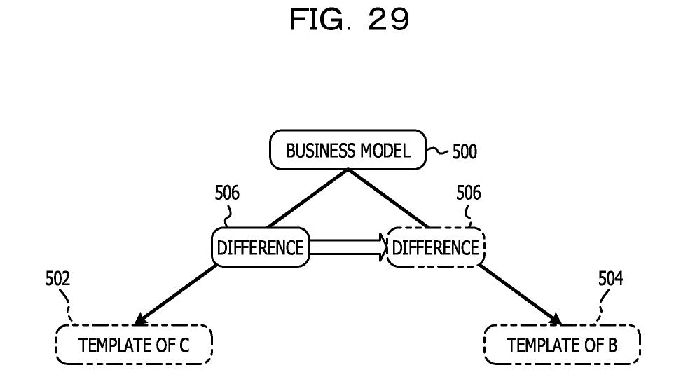

FIG. 28 illustrates an example of a relationship between a business model and a template in a case where the business model or the template is adopted. FIG. 29 illustrates an example of a relationship between a business model and a template related to the proposal to track a change of the business model or the template.

A description will be made of a case where A of the patent management division creates a business model 500 with the computer system 11, and B and C of the research and development division create templates 502 and 504 by adopting the created business model 500 in order to perform business thereof. For example, the business model 500 is a process model of patent application business including respective tasks for temporary specification creation work, technique examination work, formal specification creation work, and filing work with the Patent Office.

As illustrated in FIG. 28, B adopts the business model 500 and performs the business. In addition, after performing the business, B registers the template 504 so that the business is performed by using the business model 500, in order to improve the business. On the other hand, C thinks that information during idea extraction work which is performed before the temporary specification creation work may be reused in a case where the business is performed by adopting the business model 500, and adds a task of the idea extraction work which is not included in the business model 500 and performs the business. In other words, a task “idea registration” for extraction and sharing of idea is added before the temporary specification creation work, and then the business is performed. After performing the business, C thinks that the idea registration work is effective, and registers the template 502 of C, and a difference module 506 between the executed business process model and the business model 500 in order to improve the business.

However, since B and C register the templates independently, B does not know that the idea extraction work performed before the temporary specification creation work, registered by C in order to improve the business, is effective. Therefore, the business description management apparatus 10 according to the present embodiment proposes that the other template 504 tracks the template 502 for the business improvement. In other words, the business description management apparatus 10 according to the present embodiment proposes tracking the change of the template 502 when the changing work of the template 502 using the business model 500 which is the same adoption source as that of the template 504 is performed. That is, the business description management apparatus 10 proposes applying the difference module 506 which is applicable when the business model 500 is used as illustrated in FIG. 29.

Therefore, by proposing tracking the template 502 for business improvement and proposing the difference module 506, it is possible to improve reusability of a business model or a template through update and improvement of the template for the business model.

After B accepts the tracking proposal, it is possible to propose commonalization between the templates 502 and 504 to which the same difference module 506 is applied. Details thereof will be described later.

Next, a further description will be made of the process of the “proposal of commonalization” performed in step S448 (FIG. 22).

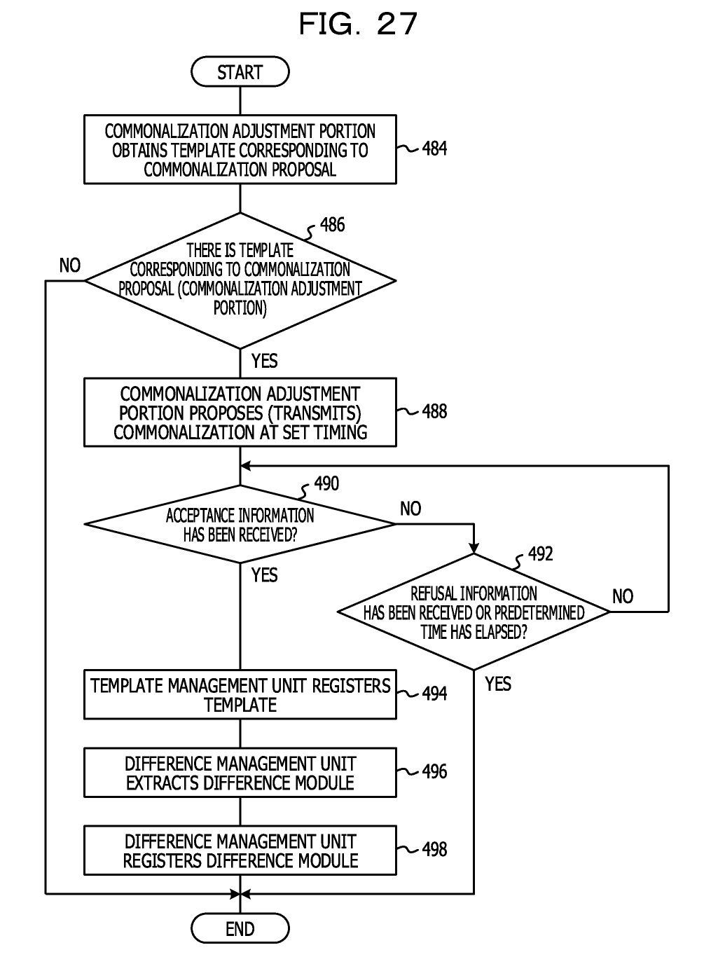

FIG. 27 illustrates an example of a process related to the proposal of commonalization in the server apparatus 30. First, the commonalization adjustment portion 108 (FIG. 3) obtains a business model or a template which is a commonalization candidate with respect to a change of a currently edited business model in step S484. Next, the commonalization adjustment portion 108 determines whether or not there is a candidate business model in step S486, and finishes the present process routine if a negative determination is performed, and makes the process proceed to step S488 if an affirmative determination is performed.

A candidate business model to which the commonalization is proposed is preferably selected according to a purpose of the organization or appropriately. As an example of the selection of a candidate business model to which the commonalization is proposed, a plurality of templates which have a common business model as an adoption source may be selected as similar templates. For example, in a case where a predefined number or more of templates to which the same difference module is applied are present among a plurality of templates targeting a business model which is a common adoption source, the templates are selected as templates to which the commonalization is proposed. As another example of the selection of a template, a plurality of templates of which a common portion of a specific amount or larger is present in a business model which is a reference designation may be selected.

Next, in step S488, the commonalization adjustment portion 108 proposes commonalization to a business model having the common portion at set timing. In other words, information indicating the commonalization proposal is transmitted to the terminal apparatus 90. On the worker side, acceptance information indicating that the proposed commonalization is accepted or refusal information indicating refusal thereof is transmitted according to the information indicating the commonalization proposal. Details thereof will be described later.

In the server apparatus 30, in step S490, the improvement control unit 104 determines whether or not the information indicating that the proposed commonalization is accepted has been received from the terminal apparatus 90, and the process proceeds to step S494 if an affirmative determination is performed. On the other hand, if a negative determination is performed in step S490, it is determined whether or not the information indicating that the proposed commonalization is refused has been received from the terminal apparatus 90, or a predetermined time has elapsed in step S492. If a negative determination is performed in step S492, the process returns to step S490, and if an affirmative determination is performed, the present process routine is finished without performing a commonalization process.

Next, in step S494, in the server apparatus 30, the template management unit 118 registers a template based on information indicating the proposed commonalization in the template DB 76. The difference management unit 120 extracts a difference module in the template which is a proposed commonalization target in step S496, registers the difference module in the difference DB 80 in step S498, and finishes the present process routine.

In the commonalization proposal process, in the same manner as in the templating proposal process, cooperation between the terminal apparatuses 90 may be performed in relation to determinations of a plurality of workers by using the cooperation modeling screen 360 (FIG. 25) of the business environment. In other words, on the cooperation modeling screen 360, a pulled-out common portion is displayed, and conference may be performed between the workers according to information (information displayed in the display region 368) from the communication portion 102. A worker who edits a template while conferring with other workers and obtains agreement of the commonalization instructs the template to be registered, and thus the template management unit 118 updates the template DB 76. In the commonalization proposal, a new template is accumulated in the template DB 76 via the template management unit 118, and the difference DB 80 and the difference applying DB 82 are also respectively updated.

On the other hand, in the terminal apparatus 90 of the worker side, in the improvement proposal accepting process for the commonalization, the CPU 91 discriminates the commonalization as the kind of improvement proposal in step S608 illustrated in FIG. 21, and makes the process proceed to step S614. In step S614, it is determined whether or not conference is performed between a plurality of workers in relation to commonalization of a template based on information which is input to the input window. If an affirmative determination is performed in step S614, information on which cooperation is performed between the plurality of workers is acquired based on the information which is input to the input window of the cooperation modeling screen 360 (FIG. 25). In step S618, the template based on the commonalization and information indicating a difference module is instructed to be registered based on the acquired information, information indicating that the improvement proposal has been accepted by the worker 140 is transmitted to the server apparatus 30, and then the present process routine is finished.

Here, a description will be made of a specific example of the proposal of commonalization of a business model or a template. Here, as an example, a description will be made of a case where B and C create respective templates by adopting the created business model 500 in order to perform business thereof.

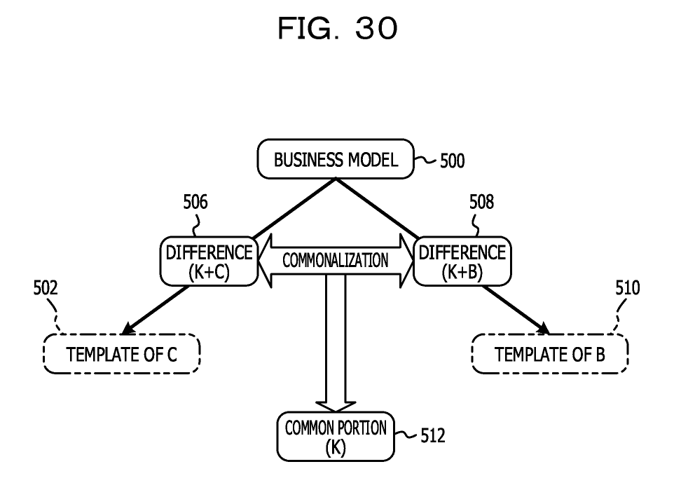

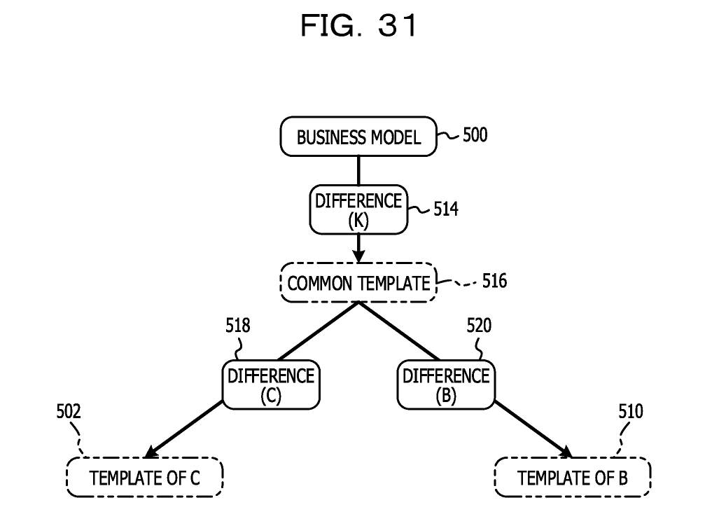

FIG. 30 illustrates an example of a relationship between a business model and a template related to a proposal of commonalization of the business model or the template. FIG. 31 illustrates an example of a relationship between a business model and a template including a commonalized template for a business model or a template.

As illustrated in FIG. 30, B adds tasks K and B and performs the business in a case of performing business by using the business model 500. After performing the business, B registers a template 510 of B, and a difference module 508 between the executed business process model and the business model 500 in order to improve the business. C adds tasks K and C and performs the business in a case of performing the business by using the business model 500. After performing the business, C registers the template 502 of C, and a difference module 506 between the executed business process model and the business model 500 in order to improve the business.

However, since B and C register the templates 502 and 510 independently, the templates may include a common portion or a similar portion. Therefore, the business description management apparatus 10 according to the present embodiment proposes commonalization based on a determination of similarity between the template 502 and the template 510. In other words, a common portion 512 between the difference modules 506 and 508 is extracted, and the extracted common portion 512 is proposed as a template candidate. B and C confer with each other about the proposed template candidate, and a template 516 is created and registered as a result of the conference. When the template 516 is registered, a difference module 514 between the business model 500 and the common template, and difference modules 518 and 520 between the executed business process models and the common template 516 are registered (refer to FIG. 31).

The conference may be performed by using a communication tool such as chatting or a mail. In addition, the conference may be performed through tagging so that a tag such as a mark is given to files or modules which are then sorted. A common conference place may be provided so that information is exchanged, and the conference may be performed by simultaneously editing information indicating a template or a difference module. An abstracting parameter may be directed toward a commonalization direction by operating an abstraction degree only or by reflecting the whole tendency in the abstraction degree.

As a specific example of a range of pulling out a common portion, there is the same department to which a worker belongs, different departments which are predefined by a worker, the same name given by a worker, different names predefined by a worker, a category in which items of target business are the same as each other, or a predefined category in which items of target business are different from each other. As an example of timing for pulling out a common portion, there is the same time, predefined different times, the time when pulling-out is performed, or the time when pulling-out is performed between a plurality of people.

As other examples of timing for pulling out a common portion, there is the following timing.
1. Timing defined at a viewpoint of a worker
2. Timing when the number of workers who complain about execution of business using a business model exceeds a predetermined number
3. Timing when requests for a business model exceeds a predetermined number, or timing when business is temporarily resolved
4. Timing when a business flow is completed or a timing defined as an off-period of business (for example, end of term is avoided)
5. Timing defined as a period of settled business
6. Timing defined at a viewpoint of a worker
7. Timing when a difference exceeds a predetermined value
8. Timing when efficiency is lower than a predetermined value
9. Timing when there is a request for reconsideration from a manager
10. Timing when the number of executors or organizations increases
11. Timing defined at a viewpoint of a system administrator
12. Timing when system performance is lower than a predetermined value (through a deep search for a difference)
13. Timing when throughput regarding exchange of information reaches a predefined value
14. Timing when response delay time such as delay time regarding information exchange reaches a predefined value

Therefore, it is possible to minimize an increase in templates similar to a business model through a proposal of commonalization based on a template similarity determination.

Next, as another specific example of the commonalization proposal, a description will be made of a proposal of commonalization of a template part of which is changed from a business model which is a source of a template which is currently being used by the worker. Here, a description will be made of a case where A wants a template 522 in which a task is added to the business model 500 to be used by B and C in the relationship between a business model and a template illustrated in FIG. 31.

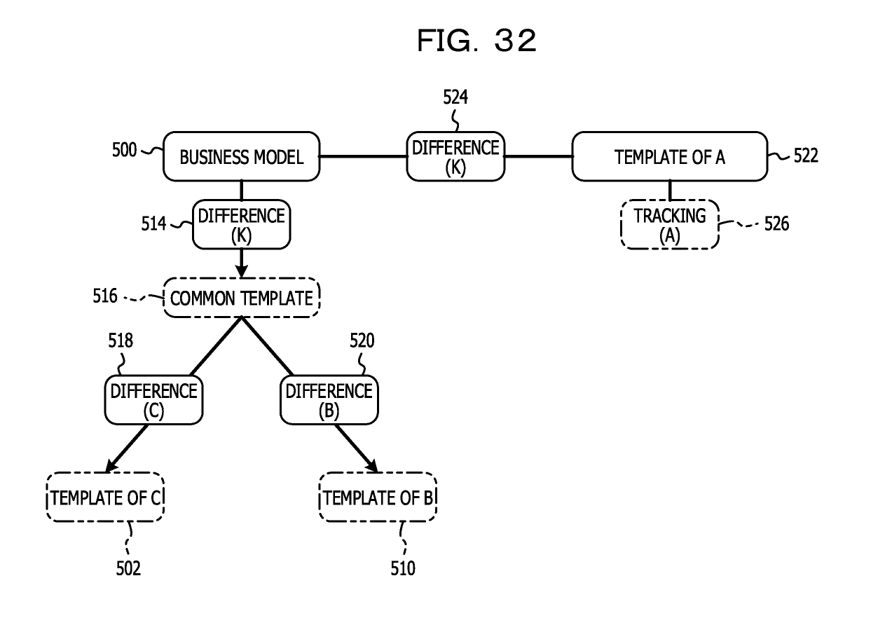

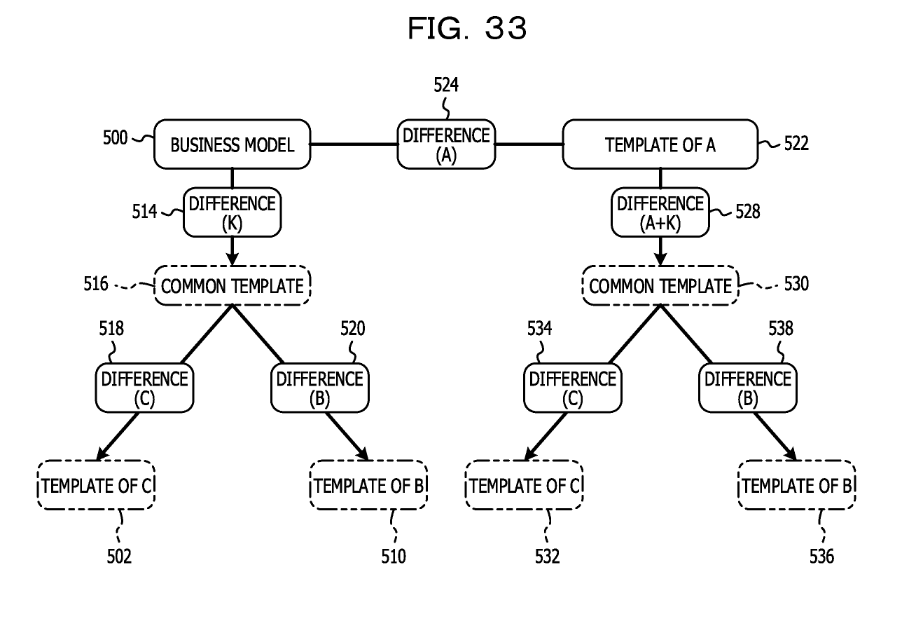

FIG. 32 illustrates an example of a relationship between a business model and a template in a case where the business model is changed due to the commonalization proposal. FIG. 33 illustrates an example of a relationship between a business model and a template as a result of the commonalization proposal.

First, A thinks that accuracy of a related art search result is desired to be improved (improvement proposal), and creates a template 522 in which “related art search result sharing” is added as a task for accumulating and sharing search results in the past by adopting the business model 500. However, since the workers B and C have already used the templates 502 and 510, the workers may be passive in using the template 522, and the improvement proposal may not be spread. Therefore, in the present embodiment, a worker proposes commonalization of a template which is changed from a business model which is a source of a template that is currently being used by the worker.

As illustrated in FIG. 32, A creates the template 522 in which the task “related art search sharing” is added to the business model. The business description management apparatus 10 requests B and C to confirm whether or not to track a change of the template 516 to a template 526. In a case where both B and C permits the tracking of the change, a template 530 is generated from the template 516, a template 532 is generated from the template 502, and a template 536 is generated from the template 510 (refer to FIG. 33). When the template 530 is generated and registered, a difference module 528 is generated and registered. In addition, when the template 532 is generated and registered, a difference module 534 is generated from the difference module 518, and when the template 536 is generated and registered, a difference module 538 is generated from the difference module 520 and is registered. In a case where mismatch occurs when the difference module is applied, a corresponding portion of the template 530 may be manually corrected in cooperation between B and C.

In a case where B does not permit the tracking, and C permits the tracking, the template 530 is generated from the common template 516, and the template 532 is generated from the template 502 of the C side which permits the tracking. At this time, in a case where mismatch occurs when the difference module 528 is applied, C may manually correct a corresponding portion of the template 530. On the other hand, the business description management apparatus 10 reconfirms B whether or not to track the change to the template 530, and if B permits the tracking, the template 536 is generated from the template 510. In a case where the template 536 is generated, B does not correct the template 530, and thus a repeated correction process is reduced. Therefore, a load of tracking a change is reduced as a whole, and this leads to a system in which a load is reduced when an improvement proposal is accepted.

In the present embodiment, a description has been made of an example in which business model update for business improvement or a process of promoting improvement, performed by the worker side, may be realized by replacing the improvement proposal with recommendation of a difference module. However, the improvement proposal accepting process illustrated in FIG. 21 on the worker side and the improvement proposal process illustrated in FIG. 22 on the server apparatus 30 side may be periodically performed. For example, the process illustrated in FIG. 22 performed by the improvement control unit 104 may be periodically performed in the server apparatus 30.

In other words, the improvement control unit 104 of the server apparatus 30 analyzes information accumulated in the business model DB 74, the template DB 76, the business history DB 72, the difference DB 80, and the difference applying DB 82 at any time, and makes various proposals to the business environment 130. Information related to business models including a currently edited business model is accumulated in each of the business model DB 74, the template DB 76, the business history DB 72, the difference DB 80, and the difference applying DB 82 accumulates by the terminal apparatuses 90 in the plurality of business environments 130.

In the server apparatus 30, in order to avoid overlapping of competitive improvement proposals, the improvement control unit 104 determines the kind of improvement proposal based on the priority in step S442. In other words, information indicating the priority is used as information indicating an improvement extent obtained in step S440. The priority may be set in each kind of improvement proposal in advance, and may be obtained through calculation. As an example of the priority obtained through calculation, as described above, an extent of an improvement effect is obtained for each improvement proposal, and priority is given to each improvement proposal so that an improvement proposal with a high extent of an improvement effect which is obtained is prioritized.

In addition, in order to periodically the process illustrated in FIG. 22, the improvement control unit 104 preferably makes an improvement proposal including a countermeasure so that a load on the worker 140 who is currently performing business is not increased, and the business is not hindered. When the improvement proposal is made, examples of the countermeasure include a countermeasure for following a proposal method of the improvement proposal, and a countermeasure for setting timing at which the improvement proposal is made. As examples of the countermeasure for following a proposal method, there is a method in which information for a pop-up notification at a screen corner of the business environment 130 is received from the interaction unit 100, or a method in which an e-mail is transmitted to an e-mail address of the worker 140 from the server apparatus 30. As the countermeasure for setting timing in which the improvement proposal is made, there is a countermeasure which is made at preset timing in a business process using a business model. As an example of the set timing, there is the time when a business process using a business model is finished, the time when a business process is temporarily resolved (for example, there is no allocation of business right before the due date), or an off-period of business (for example, end of term is avoided). The countermeasure when the improvement proposal is made may be set in each portion of the interaction unit 100 and the improvement control unit 104. A set value of the countermeasure when the improvement proposal is made may be set through determinations in the interaction unit 100 and the improvement control unit 104, and may be set individually by a worker or a use organization. A timing control portion which controls set timing may be provided in the improvement control unit 104 so as to perform control.

As described above, in the present embodiment, generation management of a template may be performed by using a difference module. In the present embodiment, adjustment may be performed so that common portions are pulled out at appropriate timing on the basis a relationship of generation and similarity of a business model. In the present embodiment, change content may be spread based on a predetermined determination when a common portion is changed. Therefore, along with business execution, a worker adjusts trade-off of diversity and maintainability of a business model through conference with other workers, and may thus optimize a maintenance cost. In addition, it is possible to promote standardization of business by accepting update or improvement of a common portion performed by other workers.

In the present embodiment, related information which contributes to modeling of business may be presented according to edited content of a currently edited business model or template, and thus it is possible to promote modeling of the business.

In the present embodiment, a common portion between a currently edited business model or template and other business models or templates is pulled out, and thus related workers may adjust the pulled-out common portion.

In the present embodiment, related information such as information indicating a proposal of business improvement is generated based on the similarity between a currently edited business model or template and other business models or templates. Therefore, it is possible to make a proposal of business improvement by using more other business models or templates in relation to the currently edited business model or template.

In the present embodiment, related information such as information indicating a proposal of business improvement is generated based on a relationship of a generation in relation to a business model or a template. Therefore, it is possible to make more proposals of business improvement by using business models or templates derived according to business.

In the present embodiment, when a common portion present in a plurality of business models or a plurality of templates is changed, change content may be spread to a plurality of target business models or a plurality of target templates through a determination of a worker. Therefore, the change may be spread to a business model or a template based on use circumstances of a worker who uses the business model or the template.

In the present embodiment, it is possible to provide information indicating a common portion present in a plurality of business models or a plurality of templates as related information. Therefore, a worker may examine changing and adding for each information piece indicating work included in a business model.

In the present embodiment, when a business model or a template which is an adoption source is changed, a business model or a template which is an adoption destination may be made to track change content through a determination of a worker. Therefore, a worker using a business model or a template may change the business model or the template in accordance with worker's intention. In addition, the worker may minimize a change of a business model or a template which has little to do with worker's intention.

The number of maintenance steps increases according to an increase in the number of creation steps of an existing business model. In the present embodiment, it is possible to minimize the number of creation steps of a business model by employing a determination of a worker.

Next, a modification example of the embodiment will be described. The modification example has the same configuration as that of the above-described embodiment, and thus only a different portion will be described.

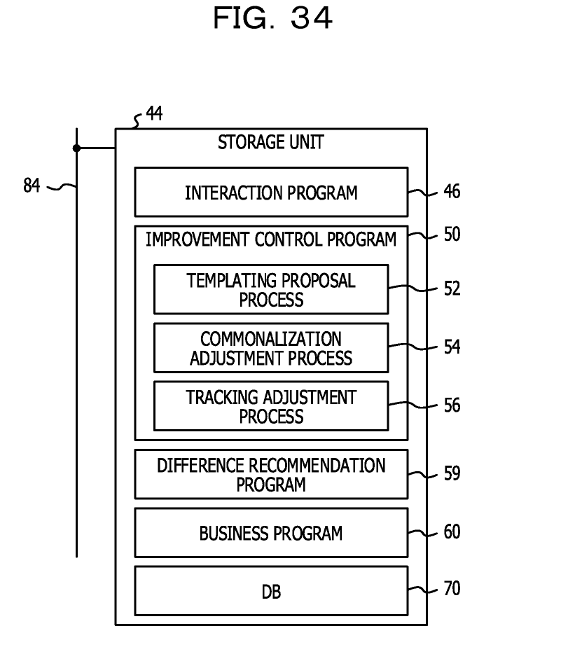

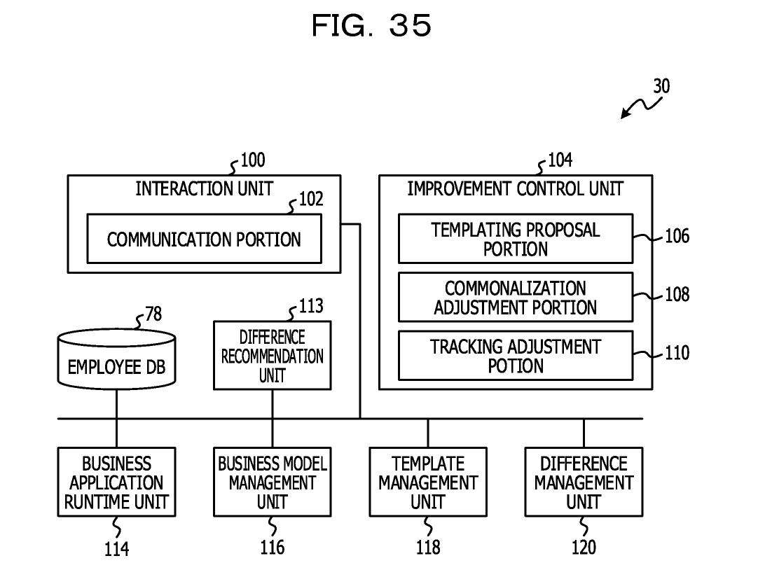

FIG. 34 illustrates the storage unit 44 of the computer system 11 as a modification example of the system in which the business description management apparatus 10 may be implemented with a computer. FIG. 35 illustrates part of the server apparatus 30 in which the computer system 11 illustrated in FIG. 34 is represented by functional blocks. A different portion between the storage unit 44 of the server apparatus 30 illustrated in FIG. 2 and the storage unit 44 of the server apparatus 30 illustrated in FIG. 34 is that the difference recommendation process 58 included in the improvement control program 50 is independently provided as a difference recommendation program 59. In addition, a difference between the server apparatus 30 illustrated in FIG. 3 and the server apparatus 30 illustrated in FIG. 35 is that the difference recommendation portion 112 included in the improvement control unit 104 is independently provided as a difference recommendation unit 113.

In the modification example, the difference recommendation process 58 included in the improvement control program 50 is independently provided as the difference recommendation program 59 (the difference recommendation portion 112 included in the improvement control unit 104 is independently provided as the difference recommendation unit 113). Consequently, the improvement control program 50 and the difference recommendation program 59 (the improvement control unit 104 and the difference recommendation unit 113) may be operated separately from each other, and thus a difference recommendation process and an improvement control process may be controlled separately from each other.

In the above description, a description has been made of an example in which the business description management apparatus 10 is implemented by the server apparatus 30. However, such a configuration is only an example, and various modifications and changes may occur within the scope without departing from the above-described technical spirit.

In the above description, a description has been made of an aspect in which the program is stored (installed) in the storage unit in advance, but the aspect is only an example. For example, the program in the disclosed technique may be provided in a form of being recorded on a recording medium such as a CD-ROM or a DVD-ROM.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A method of managing a business description, the method comprising:
monitoring an editing state of each of a plurality of business description information pieces stored in a storage device, each of the plurality of business description information pieces describing information indicating each of a plurality of items of work according to a work order;
detecting currently edited business description information of which the editing state is in an editing process;
detecting edited content of the currently edited business description information;
generating, by a processor, related information which is related to specific business description information based on information indicating edited content of the specific business description information and business description information different from the specific business description information among the currently edited business description information pieces; and
presenting the generated information.

2. The method according to claim 1, further comprising:
obtaining a relationship between the information indicating edited content of the specific business description information, and information indicating a portion identical or similar to information indicating edited content of the specific business description information in the business description information different from the specific business description information,
wherein the related information includes information indicating the obtained relationship.

3. The method according to claim 1, further comprising:
obtaining similarity between the specific business description information and the different business description information,
wherein the generating includes generating the related information based on the similarity.

4. The method according to claim 1, wherein
the specific business description information includes information indicating reference to any one of the plurality of business description information pieces stored in the storage device, and
the generating includes generating the related information based on information indicating reference to the business description information included in the specific business description information, and information indicating reference to the business description information included in the different business description information.

5. The method according to claim 1, further comprising:
causing, to be included in the related information, information indicating a proposal to spread information indicating edited content of a common business description portion to business description information different from the specific business description information including the common business description portion, in a case where the specific business description information and the business description information, stored in the storage device, different from the specific business description information include the common business description portion, and at least part of the information indicating the edited content of the specific business description information is included in the common business description portion.

6. The method according to claim 1, further comprising:
causing, to be included in the related information, information indicating a proposal to unify at least part of the information indicating the edited content of the specific business description information and business description information, stored in the storage device, different from the specific business description information.

7. The method according to claim 1, wherein
the specific business description information includes information indicating reference to any one of the plurality of business description information pieces stored in the storage device, and
the method further comprising:
causing, to be included in the related information, information indicating a proposal to perform tracking by using part of the information indicating the edited content of the specific business description information in relation to business description information, different from the specific business description information, which refers to business description information which is referred to by the specific business description information.

8. An apparatus comprising:
a memory; and
a processor coupled to the memory and configured to:
monitor an editing state of each of a plurality of business description information pieces stored in the memory, each of the plurality of business description information pieces describing information indicating each of a plurality of items of work according to a work order,
detect currently edited business description information of which the editing state is in an editing process,
detect edited content of the currently edited business description information,
generate related information which is related to specific business description information based on information indicating edited content of the specific business description information and business description information different from the specific business description information among the currently edited business description information pieces, and
present the generated information.

9. The apparatus according to claim 8, wherein the processor is configured to obtain a relationship between the information indicating edited content of the specific business description information, and information indicating a portion identical or similar to information indicating edited content of the specific business description information in the business description information different from the specific business description information,
wherein the related information includes information indicating the obtained relationship.

10. The apparatus according to claim 8, wherein the processor is configured to:
obtain similarity between the specific business description information and the different business description information, and
generate the related information based on the similarity.

11. The apparatus according to claim 8, wherein
the specific business description information includes information indicating reference to any one of the plurality of business description information pieces stored in the memory, and
the processor is configured to generate the related information based on information indicating reference to the business description information included in the specific business description information, and information indicating reference to the business description information included in the different business description information.

12. The apparatus according to claim 8, wherein the processor is configured to cause, to be included in the related information, information indicating a proposal to spread information indicating edited content of a common business description portion to business description information different from the specific business description information including the common business description portion, in a case where the specific business description information and the business description information, stored in the memory, different from the specific business description information include the common business description portion, and at least part of the information indicating the edited content of the specific business description information is included in the common business description portion.

13. The apparatus according to claim 8, wherein the processor is configured to cause, to be included in the related information, information indicating a proposal to unify at least part of the information indicating the edited content of the specific business description information and business description information, stored in the memory, different from the specific business description information.

14. The apparatus according to claim 8, wherein
the specific business description information includes information indicating reference to any one of the plurality of business description information pieces stored in the memory, and
the processor is configured to cause, to be included in the related information, information indicating a proposal to perform tracking by using part of the information indicating the edited content of the specific business description information in relation to business description information, different from the specific business description information, which refers to business description information which is referred to by the specific business description information.

15. A non-transitory computer-readable storage medium storing a program that causes a computer to execute a process, the process comprising:
monitoring an editing state of each of a plurality of business description information pieces stored in a storage device, each of the plurality of business description information pieces describing information indicating each of a plurality of items of work according to a work order;
detecting currently edited business description information of which the editing state is in an editing process;
detecting edited content of the currently edited business description information;
generating related information which is related to specific business description information based on information indicating edited content of the specific business description information and business description information different from the specific business description information among the currently edited business description information pieces; and
presenting the generated information.

16. The storage medium according to claim 15, wherein the process further comprising:
obtaining a relationship between the information indicating edited content of the specific business description information, and information indicating a portion identical or similar to information indicating edited content of the specific business description information in the business description information different from the specific business description information,
wherein the related information includes information indicating the obtained relationship.

17. The storage medium according to claim 15, wherein the process further comprising:
obtaining similarity between the specific business description information and the different business description information,
wherein the generating includes generating the related information based on the similarity.

18. The storage medium according to claim 15, wherein
the specific business description information includes information indicating reference to any one of the plurality of business description information pieces stored in the storage device, and
the generating includes generating the related information based on information indicating reference to the business description information included in the specific business description information, and information indicating reference to the business description information included in the different business description information.

19. The storage medium according to claim 15, wherein the process further comprising:
causing, to be included in the related information, information indicating a proposal to spread information indicating edited content of a common business description portion to business description information different from the specific business description information including the common business description portion, in a case where the specific business description information and the business description information, stored in the storage device, different from the specific business description information include the common business description portion, and at least part of the information indicating the edited content of the specific business description information is included in the common business description portion.

20. The storage medium according to claim 15, wherein the process further comprising:
causing, to be included in the related information, information indicating a proposal to unify at least part of the information indicating the edited content of the specific business description information and business description information, stored in the storage device, different from the specific business description information.
